(19) United States
(12) Patent Application Publication
(10) Pub. No.: US 2026/0242668 A1
(43) Pub. Date: Aug. 20, 2026

(54) COUPLER FOR MICROWAVE PYROLYSIS SYSTEMS

(71) Applicant: Pyrowave Inc., Oakville (CA)

(72) Inventors: Jocelyn Doucet, Montréal (CA); Jean-Philippe Laviolette, Montréal (CA)

(21) Appl. No.: 17/603,403

(22) PCT Filed: Apr. 3, 2020
(86) PCT No.: PCT/IB2020/053196

§ 371 Date: Oct. 13, 2021

Related U.S. Application Data
(60) Provisional application No. 62/829,947, filed on Apr. 5, 2019.
(60) Provisional application No. 62/855,077, filed on May 31, 2019.

(51) Int. Cl. C10B 19/00; B01J 6/00; B01J 19/12; C10B 53/02; C10B 53/07; H01P 3/127; H01P 5/02

(52) U.S. Cl. CPC C10B 19/00; B01J 6/008; B01J 19/126; H01P 3/127; H01P 5/02; B01J 2219/1943; B01J 2219/1946; C10B 53/02; C10B 53/07

(57) ABSTRACT

A coupler for propagating microwaves into a microwave pyrolysis reactor, the coupler including an elongated hollow body for propagating the microwaves, the elongated hollow body extending between a receiving end for receiving the microwaves and a transmitting end mountable to the microwave pyrolysis reactor for propagating the microwaves therein, the receiving end having a rectangular cross-sectional shape and the transmitting end having a circular cross-sectional shape, a shape of the elongated allow body being configured to convert a transverse (TE) mode of propagation for the microwaves at the receiving end thereof into a linearly polarized (LP) mode of propagation for the microwaves at the transmitting end thereof, and the coupler further including a barrier body inserted into the hollow body for isolating the receiving end of the elongated hollow body from the transmitting end thereof.

### TECHNICAL FIELD

The present invention relates to the field of pyrolysis, and more particularly to a coupler for microwave pyrolysis systems.

### BACKGROUND

Pyrolysis of products such as biomass and plastics is usually performed in a reactor by adding energy under anaerobic condition, i.e. in an atmosphere deprived of oxygen. There are usually three reaction products: oil, gas and carbon black. In most cases, the pyrolysis process is tuned to maximize the oil yield since it usually has the most value as a source of chemicals or fuel.

The conventional heating source for pyrolysis usually comprises combustion of a fuel-gas to make a flame and hot combustion gases or resistive electrical heating elements. In such conventional pyrolysis systems, the external surface of the reactor is heated so that heat can be transferred to the product to be pyrolyzed via heat conduction through the reactor walls.

However, at least some of the conventional pyrolysis systems have at least some of the following drawbacks.

At least some of the conventional pyrolysis systems provide low oil yield because the heating rate of the product to be pyrolyzed is relatively low, which results in low oil yield. This is due to the fact that the heating rate of the product is determined by the temperature of the vessel wall. i.e. the higher the vessel wall temperature, the higher the product heating rate. The maximum vessel wall heating rate and therefore the final temperature of the product are usually determined by thermal inertia of the vessel, the heat source power, the heat losses, the selection of vessel wall alloy, the surface area and the heat transfer coefficient. All these constraints limit the heating rate of the feedstock. However, selection of alloys that can sustain high temperatures (such as Inconel™ or titanium) increase the capital cost of the system.

Furthermore, low final product temperatures (i.e. low reaction temperatures) result in low reaction rates and also affect the kinetics. Also, since the reactor wall is heated to a temperature higher than the product to be pyrolyzed, the product experiences an increase in temperature as it leaves the reactor wall, which may cause degradation of the product.

In order to overcome at least some the above-described deficiencies of conventional pyrolysis systems, microwave pyrolysis systems have been developed. Such microwave pyrolysis systems use microwaves to heat a product to be pyrolyzed placed into a reactor.

Some of the main advantages of microwave pyrolysis systems over conventional pyrolysis systems include high heating rates which lead to high oil yields, high reaction site temperatures which leads to high reaction rates and improves the kinetics, and low environment temperatures which allows avoiding the degradation of the product of the pyrolysis reaction.

However, some issues with microwave pyrolysis systems exist. One of these issues is directed to the means by which the microwave power is delivered to the reactor. The challenge in power delivery resides in the presence of high intensity electrical fields and the presence of contaminants in chemical reactors.

Usually microwave pyrolysis systems include a microwave waveguide for propagating the microwaves generated by a microwave generator up to the reactor in which pyrolysis will occur. The usual waveguides are rectangular pipes of which the dimensions are set by the microwave wavelength/frequency and microwave reactors generally have internal dimensions that are greater than those of the waveguide. Therefore, the microwave power density is generally greater inside the waveguide (smaller volume) than in the microwave reactor.

At a fixed position inside the reactor and the waveguide, one would experience an electrical and magnetic potential that oscillates in time. If the potential increases above the breakdown voltage of the media, an electrical arc is formed. The electrical arc increases the temperature of the gas and produces a plasma. The plasma is electrically conductive and the oscillating electrical field sustains the electrical arc, which travels in the direction of the highest power density, i.e. in direction of the microwave generator. As it travels towards the microwave generator, the arc damages the metal surfaces and boundaries it touches, i.e. the arc produces sharp edges on metals. The arc can be killed by stopping the microwave injection. Once the microwave injection is resumed, the presence of the sharp edges produced by the previous arc creates points of high electrical field intensity, which increases the risk of going beyond the medium breakdown voltage and promotes the production of another arc. Therefore, the production of arcs leads to higher probabilities of arcing. Since the power density inside the waveguide is usually higher compared to the microwave reactor, the risk of arcing inside the waveguide is higher than in the reactor. Therefore, the waveguide environment must be well controlled (cleanliness, high breakdown voltage, no contamination, smooth surfaces, no sharp edges, etc.).

Pyrolysis is usually accompanied with side reactions that produce carbon black particles. These particles are electrically conductive, fine solid particles. When in suspension in a gas, the presence of carbon black particles decreases the gas breakdown voltage and promotes arcing. The presence of other gases and/or liquid produced by the reaction may also decrease the medium breakdown voltage.

Contaminants deposition on the metal surfaces may also lead to hot spots and arcing. For example, in a fixed carbon black particle, an oscillating electrical field will induce an electrical current. Since the electrical resistance of a carbon black particle is not zero, the carbon black particle heats up due to resistive losses. Hot spots may therefore be produced on metal surfaces, which may lead to surface damage, surface melting, sharp edges and/or arcing.

Regarding couplers used in usual microwave pyrolysis systems, some issues remain. Usually a coupler comprises a physical barrier which should present a low dielectric loss for preventing the dissipation of microwave energy into heat. The process therefore loses efficiency and the barrier is likely to be damaged by the temperature increase (e.g. barrier melting due to the high temperature and failure from thermal shock).

Some usual couplers use a flow of an inert gas (e.g. nitrogen) from the waveguide to the reactor to create the physical barrier. Such a physical barrier can be used for reactors for which the coupler is located in a gas medium otherwise liquids or solids would flow into the waveguide. Such an inert gas barrier requires a high flow of gas, which adds cost for the gas production, and also separation downstream from the pyrolysis products. Furthermore, it may be difficult to prevent contamination from entering the waveguide since pressure fluctuations in the reactor may entrain contaminants into the waveguide.

Some other usual couplers use Teflon™ windows as physical barriers, which have a typical operating temperature of 260° C. This relatively low operating temperature limits the applicability of Teflon™ to low temperature chemical processes. Furthermore, deposition of contaminants such as carbon black particles on a Teflon™ window may result in hot spots on the Teflon™ window surface, which may melt and damage the Teflon™ window. Damage to the Teflon™ window jeopardizes the ability of the physical barrier from preventing contaminants from entering the waveguide. Furthermore, damage to the Teflon window creates zones where solid contaminants are more likely to accumulate leading to more hot spots and arcing across the Teflon window because the solid contaminants can make a conductive path.

Other types of couplers use quartz windows. Quartz has an operating temperature in the range of 1400° C. However, in the case of an arc, a quartz window may not sustain the high temperature of the arc and may therefore be damaged. The effects of this damage are the same as the above-described damages for Teflon™.

Conventional microwave pyrolysis systems use microwave waveguides having a rectangular cross-sectional shape. In such as a rectangular microwave waveguide, the highest electrical field intensity is located at the middle of the long edge of the waveguide. This corresponds to the TE₁₀ transmission mode, which is the dominant mode for rectangular waveguides. In this case, the deposition of contaminants may lead to hot spots on the metal, metal damage, product of sharp edges and/or arcing.

Furthermore, impedance matching in microwave systems is usually required to maximize the transmitted power from the microwave generator to the reactor and minimize the reflected power. Impedance matching is usually performed using an iris or stub tuners. The iris is a perforated plate and its impedance is a function of the hole size and geometry. Since both size and geometry are fixed, the impedance of an iris is fixed and may not be changed in real-time during microwave injection into the reactor. An iris is therefore a static impedance matching system.

A tub tuner usually consists of a waveguide section provided with cylindrical stubs (usually 3 stubs) or plungers that are inserted along its long edge. The insertion depth can be varied to change the characteristic impedance of the tuner. Most stub tuners allow the changing of each individual stub's insertion depth in real-time during microwave injection. A stub tuner is therefore a dynamic impedance matching system.

When they are inserted in the microwave field, the stubs are subjected to an electrical and magnetic field, which induces an electrical current on the stub surface. Since the stub material has a non-zero electrical resistance (stubs are usually made of aluminum or copper), resistive heat losses occur on the stubs. Some resistive losses also occur on the waveguide wall, but it is negligible compared to the losses on the stubs. Due to those resistive losses on the stubs, the stubs heat up and its temperature increases. As the stub temperature increases, the stub undergoes thermal expansion such that its length and diameter increases. Because of the thermal expansion, the stub may get squeezed inside the stub casing and may no longer be moved in and out of the tuner. The system then loses its ability to change the tuner's impedance. Furthermore, forcing the stub to move or out may cause mechanical damage to the stub and stub casing.

Therefore, there is a need for an improved microwave pyrolysis system including an improved coupler used for injecting microwaves into a reactor, that overcomes at least some of the above-identified drawbacks of prior art systems.

### SUMMARY

According to a broad aspect, there is provided a coupler for propagating microwaves into a microwave pyrolysis reactor, the coupler comprising: an elongated hollow body for propagating the microwaves, the elongated hollow body extending between a receiving end for receiving the microwaves and a transmitting end mountable to the microwave pyrolysis reactor for propagating the microwaves therein, the receiving end having a rectangular cross-sectional shape and the transmitting end having a circular cross-sectional shape, a shape of the elongated allow body being designed so as to convert a transverse (TE) mode of propagation for the microwaves at the receiving end thereof into a linearly polarized (LP) mode of propagation for the microwaves at the transmitting end thereof; and a barrier body inserted into the hollow body for isolating the receiving end of the elongated hollow body from the transmitting end thereof.

In one embodiment, the elongated hollow body comprises: a mode conversion body for receiving the microwaves and converting the TE mode of propagation of the received microwaves into the LP mode of propagation; and a connection body mountable to the microwave pyrolysis reactor for propagating the microwaves having the LP mode of propagation therein, the connection body being hollow and the barrier body being inserted into the connection body.

In one embodiment, the mode conversion body comprises a hollow and tapered body defining a conversion cavity extending therethrough, and the connection body comprises a tubular body defining a receiving cavity, the barrier body being inserted into the receiving cavity.

In one embodiment, the hollow and tapered body extends between a first end having a rectangular shape for receiving the microwaves and a second end having a circular shape for coupling the microwaves into the connection body, a shape of the hollow and tapered body being tapered between the first and second ends thereof for converting the TE mode of propagation into the LP mode of propagation.

In one embodiment, a cross-sectional size of the first end of the hollow and tapered body is less than a cross-sectional size of the second end of the hollow and tapered body.

In one embodiment, the tubular body comprises an internal cylindrical surface surrounding the receiving cavity, at least a section of the internal cylindrical surface being tapered, and wherein a lateral surface of the barrier body is tapered so that the barrier body has a truncated conical shape and the barrier body is inserted into the receiving cavity.

In one embodiment, the tubular body extends longitudinally between a first end connected to the mode conversion body and a second end mountable to the microwave pyrolysis reactor, an internal diameter of the first end of the tubular body being greater than an internal diameter of the second end of the tubular body.

In one embodiment, the coupler further comprises a seal body having a tapered tubular shape, the seal body being inserted into the tubular body and the barrier body being inserted into the seal body.

In one embodiment, the coupler further comprises a backup body having a tubular shape inserted into the tubular body so that the barrier body be positioned between the backup body and the second end of the tubular body.

In one embodiment, the tubular body extends longitudinally between a first end connected to the mode conversion body and a second end mountable to the microwave pyrolysis reactor, an internal diameter of the second end of the tubular body being greater than an internal diameter of the first end of the tubular body.

In one embodiment, the coupler further comprises a seal body having a tapered tubular shape, the seal body being inserted into the tubular body and the barrier body being inserted into the seal body.

In one embodiment, an internal diameter of the tubular body is at least equal to a wavelength of the microwaves.

In one embodiment, a length of the hollow and tapered body is longer than half of the wavelength of the microwaves and shorter than 5 times the wavelength of the microwaves.

In one embodiment, the mode conversion body and the connection body are integral.

In one embodiment, the mode conversion body and the connection body are removably secured together.

In one embodiment, the coupler further comprises a gasket inserted between the mode conversion body and the connection body.

In one embodiment, the coupler further comprises a port for injecting a fluid within the coupler.

In one embodiment, the port is located on the mode conversion body.

In one embodiment, the barrier body is made of a material that at least one of maximizes a microwave transmission and reduces a dissipation of microwave energy.

In one embodiment, the barrier body is made of one of: Teflon™, aluminum oxide, silicon nitride and quartz.

Microwaves are electromagnetic waves: a traveling electrical field perpendicular to a magnetic field. Microwaves used for heating applications have frequencies of 2.45 GHz (low power below 15 kW) and 915 MHz (high power as high as 100 kW)—these frequencies are fixed and determined by international regulations

### BRIEF DESCRIPTION OF THE DRAWINGS

Further features and advantages of the present invention will become apparent from the following detailed description, taken in combination with the appended drawings, in which:

FIG. 1 is a cross-section of a microwave pyrolysis system comprising a microwave pyrolysis reactor, a coupler and a tuner, in accordance with a first embodiment;

FIG. 2-5 illustrate different views of the microwave pyrolysis reactor of FIG. 1;

FIG. 6 illustrates a microwave absorbing particle, in accordance with an embodiment;

FIG. 7 illustrates the heating of a reactant particle, in accordance with an embodiment;

FIG. 8 illustrates a microwave pyrolysis reactor provided with an agitator device, in accordance with an embodiment;

FIG. 9 is a flow chart of a method for pyrolyzing a product, in accordance with an embodiment;

FIG. 10 illustrates a microwave pyrolysis system comprising a mixing tank for performing the method of FIG. 8, in accordance with an embodiment;

FIGS. 11 and 12 illustrate the mixing tank of FIG. 10;

FIGS. 13 and 14 are exploded views of a coupler for injecting microwaves into a microwave pyrolysis reactor, in accordance with a first embodiment;

FIG. 15 illustrates the coupler of FIGS. 13 and 14 once assembled;

FIGS. 16 and 17 are exploded views of a coupler for injecting microwaves into a microwave pyrolysis reactor, in accordance with a second embodiment; and

FIG. 18 illustrates the coupler of FIG. 15 from which a connection plate has been omitted to form a protruding design, in accordance with an embodiment.

It will be noted that throughout the appended drawings, like features are identified by like reference numerals.

### DETAILED DESCRIPTION

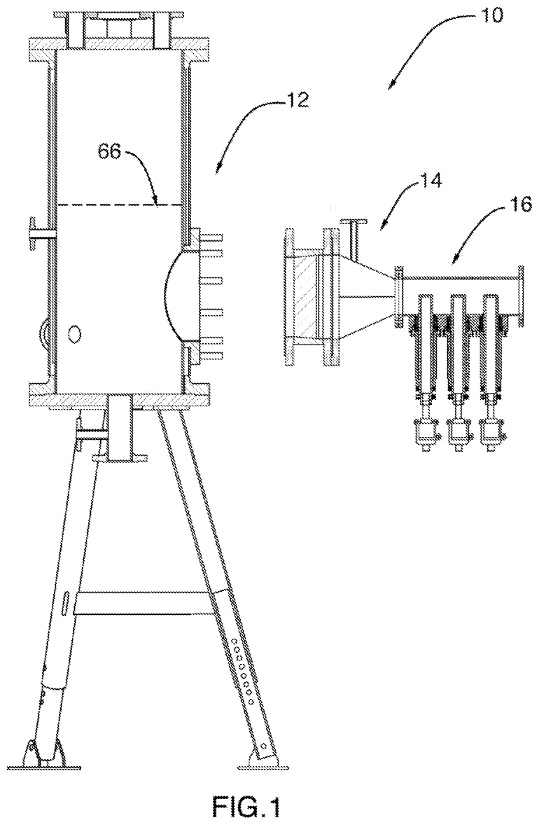

FIG. 1 illustrates one embodiment of a microwave pyrolysis system 10 which comprises a reactor or vessel 12, a coupler 14 and a tuner 16. It should be understood that the tuner 16 is connectable to a source of microwaves or microwave generator (not shown) either directly or via a microwave waveguide. In the illustrated embodiment, the tuner 16 is used for guiding the microwave emitted by the microwave generator up to the coupler 14. The tuner 16 may further be used for adjusting the power of the energy of the microwaves delivered to the coupler 16 and therefore to the reactor 12. The coupler 14 is used for propagating the microwaves coming from the tuner 16 into the reactor 12. The reactor 12 is configured for receiving therein a product to be pyrolyzed which is heated by microwave heating.

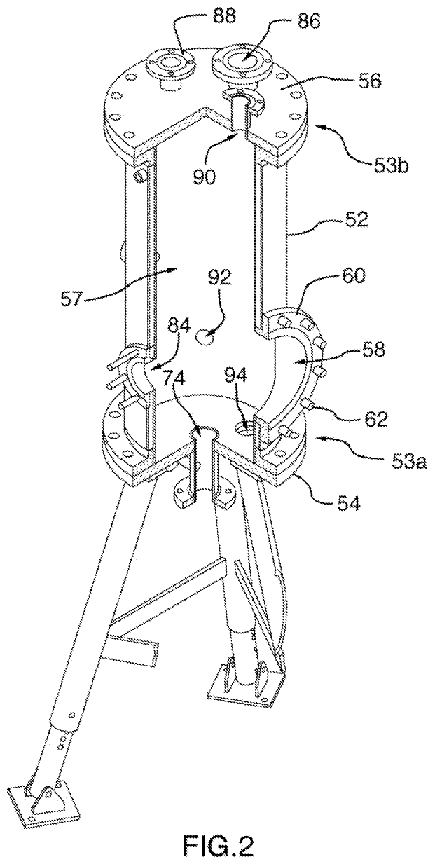

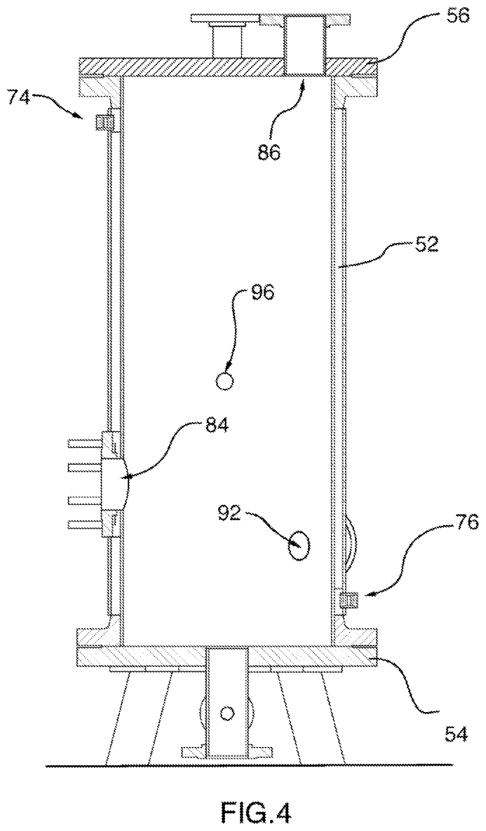

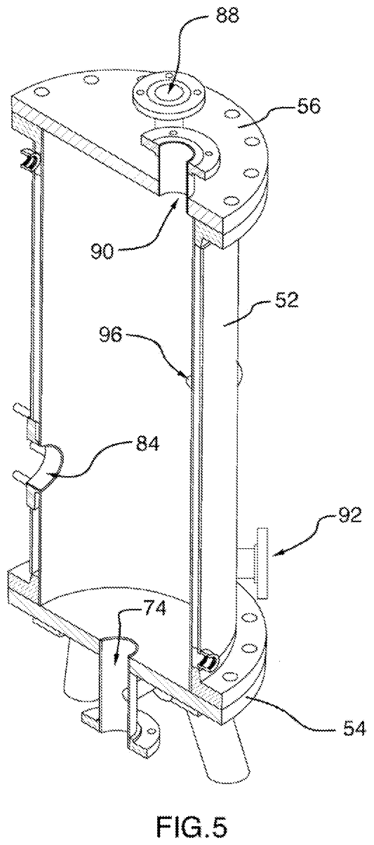

Referring to FIGS. 2 to 5, there is illustrated one embodiment for the reactor 12. The reactor 12 is configured for performing chemical and/or physical reactions therein under the action of microwave energy.

In the illustrated embodiment, the reactor 12 comprises a tubular body 52 extending along a longitudinal axis between a first or bottom end 53a and a second or top end 53b, a bottom body or floor 54 and a top body or cover 56. The tubular body 52 defines a cavity 57 in which the product to be pyrolyzed is to be received. The bottom body 54 is secured to the bottom end 53a of the tubular body 52 and has a size that is at least equal to the cross-sectional size of the bottom end of the cavity 57 so as to close the bottom end 53a of the tubular body 52. The top body 56 is secured to the top end 53b of the tubular body 52 and has a size that is at least equal to the cross-sectional size of the bottom end of the cavity 57 so as to close the top end 53b of the tubular body 52. When the bottom and top bodies 54 and 56 are secured to the tubular body 52, the assembly form an enclosure in which the product to be pyrolyzed is placed. In one embodiment, the connections between the tubular body 52 and the bottom and top bodies 54 and 56 are substantially hermetical so than no fluid may exit the enclosure. For example, gaskets may be positioned between the tubular body 52 and the bottom and top bodies 54 and 56 for ensuring that the enclosure is substantially hermetically closed.

The reactor 12 is provided with a first aperture 58 through which microwaves are injected into the interior space of the reactor 12. A microwave guiding device operatively connected to the source of microwaves is securable to the external face of the tubular body 52 around the aperture 58 for propagating the microwaves from the source of microwaves into the cavity 57. In the illustrated embodiment, a connection plate 60 projects from the external face of the tubular body 52 around the aperture 58. The connection plate 60 is provided with a plurality of bolts or rods 62 which each protrude outwardly from the connection plate 60. In this case, the microwave guiding device is provided with a connection plate mating the connection plate 60 and provided with holes therethrough, each for receiving a respective bolt 62 therein in order to secure the microwave guiding device to the reactor 12.

In one embodiment, the microwave guiding device is a microwave waveguide. In another embodiment, the microwave guiding device is a coupler such as coupler 14.

In one embodiment, the aperture 58 has a circular shape as illustrated in FIG. 2. In another embodiment, the aperture 58 is provided with a rectangular shape such as a square shape. It should be understood that the shape of the aperture 58 is chosen as a function of the microwave guiding device to be secured to the reactor 12 for propagating microwaves therein.

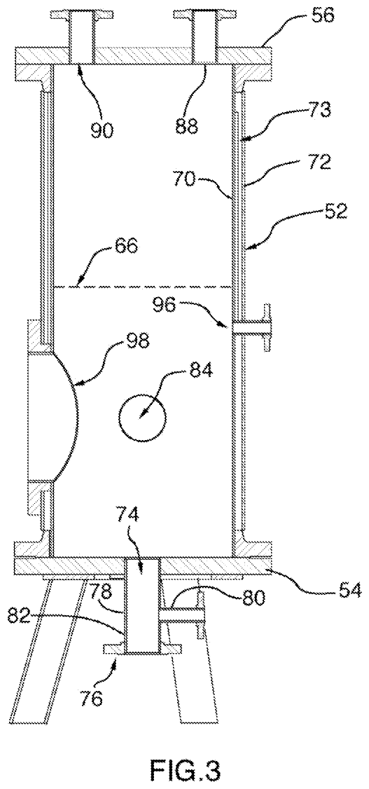

In one embodiment, the aperture 58 is provided on the tubular body 52 adjacent to the bottom end thereof. In one embodiment such as an embodiment in which the reactor 12 is used for pyrolyzing a liquid or slurry product, the reactor 12 is provided with a fill level 66 representing a desired level of product or a minimal level of product within the reactor 12. In this case, the position of the aperture 58 is chosen to be below the fill level 66, as illustrated in FIG. 3.

While FIGS. 1-5 illustrate the aperture 58 provided on the tubular body 52, the person skilled in the art would understand that the aperture for injecting the microwaves into the reactor 12 may be provided on the bottom body 54 or the top body 56.

In one embodiment, at least a section of the tubular body 52 is configured for receiving and propagating a temperature control fluid therein in order to control the temperature of the reactor 12 and/or the product contained within the reactor 12. In the illustrated embodiment, the tubular body 52 comprises an internal tubular wall 70 and an external tubular wall 72, as illustrated in FIG. 3. The internal wall 70 is positioned inside the external wall 72 and the internal and external walls 70 and 72 are spaced apart from one another by a gap 73 to form together a double wall structure. The gap 73 between the two walls 70 and 72 has a width which is less than the thickness of the tubular body 52 and may be used for propagating the temperature control fluid. In the illustrated embodiment, the external wall 72 is provided with an inlet 74 extending through the external wall 72 and an outlet 76 also extending through the external wall 72. In the illustrated embodiment, the inlet 74 is located adjacent to the top end 53b of the tubular body 52 on a first side thereof and the outlet 76 is located adjacent to the bottom end 53a of the tubular body 52 on a side opposite to the first side. However, the person skilled in the art will understand that this configuration is exemplary only and the positions of the inlet 74 and the outlet 76 may vary. The inlet 74 is connected to a source of temperature control fluid (not shown) so that the temperature control fluid is injected through the inlet and exits the tubular body 52 through the outlet 76. The source of fluid is provided with a heating/cooling device for adjusting the temperature of the fluid to a desired temperature. The desired temperature may be chosen so as to heat the reactor 12 before the product to be pyrolyzed be introduced therein, control the temperature of the product during the propagation of the microwaves within the reactor 12, etc.

In one embodiment, the inlet 74 and the outlet 76 are fluidly connected together via a tube (not shown) extending within the gap 73 between the internal and external walls 72 and 74. For example, the tube may extend around substantially the whole circumference of the internal wall 72 and may have a coil shape so to be wrapped around the internal wall 72.

While in the illustrated embodiment the tubular body 52 comprises two distinct walls 70 and 72 spaced apart by the gap 73, the tubular body 52 may be formed of a single solid wall and a canal or aperture may extend partially through the thickness of the solid wall between the inlet 74 and the outlet 76. The canal is then used for propagating the temperature control fluid in order to adjust the temperature of the reactor 12 to a desired temperature. In one embodiment, the tubular body 52 may be provided with a plurality of canals for circulating the temperature control fluid. The canals may each extend between a respective inlet and a respective outlet. In another example, the canals may be fluidly connected together so that a single inlet and a single outlet may be present.

In one embodiment, only a portion of the tubular body 52 is configured for receiving and propagating a temperature control fluid. For example, only the bottom section of the tubular body 52 may be provided with a double wall while the remaining of the tubular body 52 comprises a single solid wall. As a result, the temperature of only the bottom section of the reactor 12 may be controlled via the flow of the temperature control fluid. For example, only the portion of the tubular body 52 located below the fill level 66 may be provided with a double wall structure.

In one embodiment, the reactor 12 further comprises at least one temperature sensor for sensing the temperature of the temperature control fluid. In the same or another embodiment, the reactor 12 is provided with at least one flow sensor for sensing the flow of the temperature control fluid. It should be understood that the temperature sensor(s) and/or the flow sensor(s) can be located at any adequate location to measure the temperature and/or the flow rate of the temperature control fluid, respectively.

In one embodiment, the reactor 12 is provided with an aperture for inputting the product to be pyrolyzed inside the reactor 12. In the illustrated embodiment, the bottom body 54 is provided with an aperture 74 that may be used for injecting the product to be pyrolyzed into the reactor 12.

In one embodiment, the reactor 12 further comprises a T-shaped connector 76 having three fluidly interconnected ports/tubes 78-82, as illustrated in FIGS. 1-5. The first tube 78 is secured to the bottom body 54 around the aperture 74 so as to fluidly connect the reactor 12 to the connector 76. The tube 80 may be fluidly connected to a source of product to be pyrolyzed in order to inject the product into the reactor 12. The tube 82 may be used as an evacuation drain for evacuating the product contained in the reactor 12 in case of an emergency situation where unloading is necessary or in case of planned discharge of the reactor 12. The inlet/outlet of the tube 82 may be provided with a pressure relief valve in order to prevent overpressure in the reactor 12.

In one embodiment, the reactor 12 is provided with an extraction aperture 84 for extracting reacted product, removing impurities, and/or the like. In the illustrated embodiment, the extraction aperture 84 is located on the tubular body 52 below the fill level 66. The extraction aperture 84 may be useful to control the residence time of the product within the reactor 12 or if non-soluble impurities need to be filtered or removed from the reacted product. The extraction aperture 84 may also be useful to purge a portion of the reactor's content to control concentration of specific impurities for example.

In one embodiment, the reactor 12 is provided with a gas aperture 86 for allowing gases generated during the pyrolysis reaction to be evacuated outside of the reactor 12. In one embodiment, the gas aperture 86 is located on the top body 56. In one embodiment, the gas aperture 86 is fluidly connected to a condenser for condensing the gas coming from the reactor 12. In one embodiment, a gas/liquid separator is inserted at the gas aperture 86 for preventing entrainment of liquid from the reactor 12 in the condenser system in order to avoid blockage or fouling of the condenser tubes for example.

In an embodiment in which the system comprises a condenser, the condensed gas phase can be partially or completely recycled back in the reactor 12 to increase the residence time of the reacted product in the reactor 12 via the tube 82 for example.

In an embodiment in which microwave absorbing particles are to be used (as described below), the reactor 12 is provided with an aperture 88 for inserting the microwave absorbing particles inside the reactor 12. In one embodiment, the aperture 88 is located on the top body 56.

In one embodiment, the reactor 12 is provided with a pressure relief aperture 90 for protecting the reactor 12 from overpressure. A pressure relief valve may be connected to the aperture 90 for allowing gas to exit the reactor 12 when the pressure is greater than a predefined pressure.

In one embodiment, the reactor 12 comprises at least one aperture for allowing the insertion of at least one sensor into the reactor 12. In the illustrated embodiment, the reactor 12 is provided with a pressure aperture 92 for inserting a pressure sensor in the reactor 12 and two temperature apertures 94 and 96 each for inserting a temperature sensor in the reactor 12. In the illustrated embodiment, the temperature aperture 94 may be used for the sensing the temperature at the bottom of the reactor 12 adjacent to the bottom body 54 while the temperature aperture 96 may be used for measuring the temperature below and adjacent to the level line 66.

In the illustrated embodiment, a connector is associated with each aperture 86, 88, 90, 92, 94 and 96. Each connector comprises a tube projecting from the external surface of the reactor 12. Each tube extends between a first end secured around the respective aperture, and a second end. A flange extending around the second end of each tube is provided with a plurality of holes for allowing the securing of another tube.

In one embodiment, the bottom and top bodies 54 and 56 are removably secured to the tubular body 52. In this case, it should be understood that any adequate method/system for removably securing the bottom and top bodies 54 and 56 to the tubular body 52 may be used. In the illustrated embodiment, the tubular body 52 is provided with a bottom flange which projects radially and outwardly around the bottom end of the tubular body 52 and a top flange which projects radially and outwardly around the top end of the tubular body 52. Both flanges are each provided with a plurality of holes which extend through a thickness thereof. The bottom and top bodies 54 and 56 are each provided with holes positioned adjacent to an outward end along the circumference thereof. Bolts and nuts may then be used for securing the bottom body 54 to the bottom flange, and the top body 56 to the top flange.

In one embodiment, the bottom and top bodies 54 and 56 are hermetically and removably securable to the tubular body 52. In this case, at least one gasket may be inserted between the bottom body 54 and the bottom flange and between the top body 56 and the top flange.

In another embodiment, the bottom and top bodies 54 and 56 are fixedly secured to the tubular body 52. For example, they may be welded to the tubular body 54.

In one embodiment, the location of at least some of the apertures 74, 84, 86, 88, 90, 92, 94 and 96 may vary from the location illustrated in FIGS. 1-5.

In one embodiment, the reactor 12 is further provided with an agitator device for agitating/mixing the product contained therein during the reaction. For example, a mechanical agitator may be secured to the top face of the bottom body 54. In another example, gas such as inert gas may be injected in the slurry phase material during the reaction to generate bubbles and thereby mix/agitate the slurry phase material.

The above-described reactor 12 may be used for pyrolyzing a gas product, a liquid product or a solid product. In the following, the operation of the reactor 12 is described for the pyrolysis of a liquid product.

The liquid product to be pyrolyzed is injected into the reactor via the port 80 of the connector 76 and the aperture 74 present in the bottom body 54. The volume of liquid product injected into the reactor 12 is chosen so that the top surface of the liquid product once in the reactor 62 be substantially coplanar with the level line 66 to ensure that the whole surface of the aperture 58 be covered with the liquid product.

Microwaves are then injected into the reactor 12 via the aperture 58. The liquid product then interacts with the microwave electrical field to convert the liquid product into a slurry phase. In one embodiment, the interaction of the liquid product with the microwaves is direct so that the liquid product is directly heated by the microwaves. In another embodiment, the heating of the liquid product is indirect. In this case, microwave absorbing particles are introduced into the liquid product. The microwave absorbing particles are then used for converting the microwaves into heat and the liquid product is heated by convection/conduction to create the slurry phase.

In one embodiment, the reactor 12 may be purged prior to the propagation of the microwaves into the reactor 12 to remove traces of oxygen if the reaction requires anaerobic conditions. In this case, gas such as nitrogen or any adequate purge gas may be introduced into the reactor 12.

In one embodiment, liquid product is continuously introduced into the reactor 12 while microwaves are propagated therein. In this case, the feed rate of the liquid product into the reactor 12 is chosen so that the fill level 66 of liquid product in the reactor 12 be maintained to ensure that the aperture 58 be covered with the slurry phase and isothermal conditions be present on the coupler interface.

During the reaction, i.e. during the propagation of the microwaves within the reactor 12, some of the slurry phase may be continuously extracted from the reactor 12 through the aperture 84 to remove impurities or extract partially reacted product The extraction of slurry phase material may be useful when the residence time of the slurry phase material within the reactor 12 needs to be controlled, when non-soluble impurities need to be filtered or removed from the slurry phase, when the concentration of specific impurities need to be controlled and/or the like.

In one embodiment, the temperature of the product contained within the reactor 12 is controlled by injecting a temperature control fluid into the double wall of the tubular body 52 via the inlet 74. The temperature of the slurry phase material contained in the reactor 12 can be adjusted to a desired temperature such as a temperature ensuing isothermal conditions in the reactor 12 by adequately adjusting the temperature and/or flow of the temperature control fluid injected into the double wall of the tubular body 52. It should be understood that the temperature of the slurry phase material may be determined using the temperature sensors inserted into the apertures 94 and 96 of the reactor 12. In one embodiment, the temperature control is used for maintaining a temperature gradient between the reaction sites and the slurry phase material and favoring a given reaction over others.

In one embodiment, the reactor 12 may be pre-heated to a desired temperature before the injection of the liquid material within the reactor 12.

In one embodiment, the reactor 12 may operate under atmospheric pressure, at pressure greater than the atmospheric pressure or at vacuum conditions to favor certain reactions selectivity if desired or required.

In one embodiment, the reactor 12 is made of stainless steel. In one embodiment, the reactor 12 is made of a material having a low dielectric loss and a high electrical conductivity to prevent heat loss in the reactor's vessel which may reduce the energy efficiency transferred to the reaction.

In an embodiment in which the product to be pyrolyzed is liquid and while the microwaves propagate within the reactor 12, some reactions occur in the slurry phase that cracks the slurry phase molecules to smaller molecules and may also generate gaseous products depending on the reactor's conditions. This gas generation produces bubbles through the slurry phase and promotes mixing of the slurry phase. The cracking reactions also reduce the slurry phase viscosity, which further facilitates mixing of the slurry phase. The thus-obtained mixing of the slurry phase maintains suspension of the microwave absorbing particles in the slurry phase and the best resistive conditions in the reactor 12 to maximize the microwave absorption. The mixing of the slurry phase also promotes a homogeneous slurry phase and the mass transfer to the reaction sites.

The reaction usually occurs on the surface of the microwave absorbing particles, unless the slurry phase is also absorbing partially or totally the microwave energy. The microwave absorbing particles may be composed of chemically inert carbonaceous material or chemically active catalytic material to enhance and favor predefined and desired reactions under the action of microwaves. The surface of the particle is normally at a higher temperature than that of the slurry phase and therefore the products generated during the reaction are produced at a higher temperature than that of the slurry phase. When the gas containing the reaction products is bubbling through the slurry phase, some heat is released into the slurry phase and the generated gas is cooled down rapidly at a temperature being not lower than the temperature of the slurry phase. This rapid cooling down of the gas stops side reactions that may be undesirable and therefore favors higher selectivity towards desired products.

In one embodiment, the internal diameter d of the reactor 12 is equal to or greater than the wavelength of the microwaves injected into the reactor 12. For microwaves having a frequency f, the internal diameter d of the reactor 12 is equal to or greater than c/f where c is the speed of light. Typically, for standard 915 MHz microwaves, the internal diameter of the reactor 12 is equal to or greater than 0.32 m.

In one embodiment, the reactor 12 contains a mass of microwave absorbing particles mₚ with high dielectric loss that will convert the microwave electrical field into heat. These particles are free moving in the slurry phase under the action of bubbles formed by the generation of gas during the reaction or by forced convection provided by a recirculating pump for example.

The microwave absorbing particles are free-flowing in the slurry phase under natural or forced convection, which allows a better distribution of absorbing particles inside the reactor 12 which increases the overall resistive nature of the reactor's impedance. The increase of the overall resistive nature of the reactor's impedance in return makes easier the tuning of the resonant system comprising the microwave source and the reactor 12. For example, if the particles were not flowing freely, it would become more difficult to tune the system and therefore the reactor's energy performance would decrease as a result of an impedance mismatch which would cause the transmitted energy to the reactor to decrease. Furthermore, tuning a high mismatch also increases the resistive losses on the tuner, which results in lost energy (heat).

In one embodiment, the microwave absorbing particles are added in the reactor 12 before the injection of the microwaves in the reactor 12. If some microwave absorbing particles are lost during the operation of the reactor 12 as a result of attrition, entrainment or purge, additional microwave absorbing particles may be added during the reaction if needed.

In one embodiment, desired reactions and therefore desired end result chemicals can be achieved by controlling the temperature gradient or difference between the microwave absorbing particles and the slurry phase, as described in the following. Since the slurry phase has a low thermal conductivity k_{b}, the absorbing particles are partially thermally insulated from the rest of the reactor. Under continuous microwave power flux (P) which provides a continuous flux of heat to the microwave absorbing particles and since the microwave absorbing particles are partially insulated from the slurry phase, the temperature T_{P} of the microwave absorbing particles may rise and a temperature gradient or difference ΔT is created between the microwave absorbing particles and the slurry bulk: ΔT=T_{P}−T_{b}, where T_{b} is the temperature of the slurry bulk. In one embodiment, the magnitude of the temperature gradient ΔT is used to achieve high selectivity of key chemicals:
the controlled reaction temperatures on the particle surface promote desired reactions to produce the desired key chemicals; and
a lower slurry bulk temperature T_{b} quenches further reactions to avoid decomposition of the desired key chemicals.

The temperature gradient ΔT can be adjusted to a desired value by adjusting various parameters on the reactor 12.

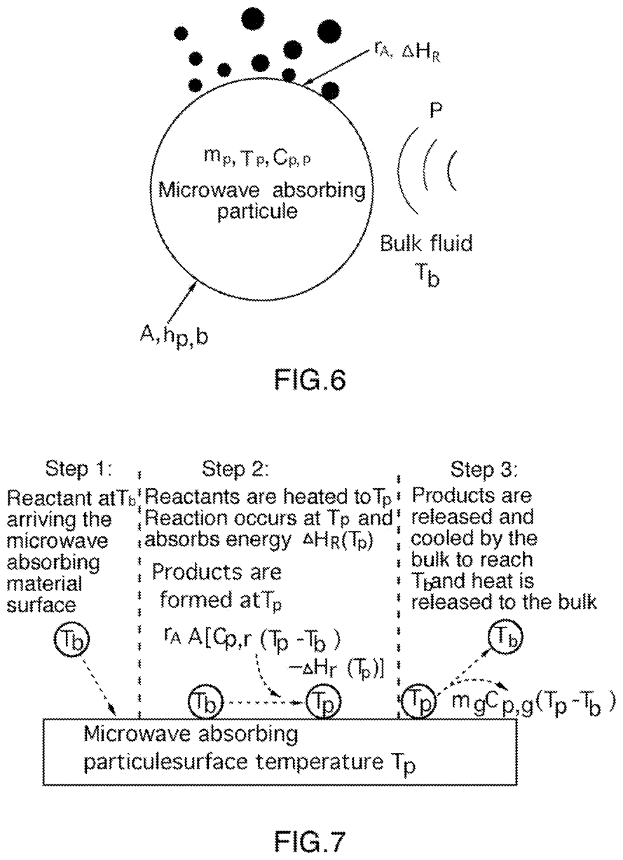

To explain how the reactor controls this gradient, an energy balance on the microwave absorbing particle may be performed as follows in reference with FIG. 6:

$${m}_{p} {C}_{p , p} \frac{{dT}_{p}}{dt} = P - {r}_{A} A ( {Δ H}_{R} ) - {h}_{p , b} A {\underbrace{( {T}_{p} - {T}_{b} )}}_{Δ T} - σϵA ( {T}_{P}^{4} - {T}_{b}^{4} ) \qquad ( Eq . 1 )$$

where mₚ is the mass of particles (kg), C_{p,p} is the specific heat of the microwave absorbing particles (J/kg−K), P is the microwave power (W), A is the total surface area (m²) of the absorbing particles (A=mₚ×a) and a (m²/kg) is the specific surface area of the particle, r_{A}(Tₚ, Re_{b}) is the reaction rate occurring at the surface of the particle (kg/m²−s), which is a function of the particle temperature (Tₚ) and the boundary layer on the particle surface which is function of the bed Reynolds number (Re_{b}). ΔH_{R}(Tₚ) is the heat of reaction (J/kg) at the particle surface temperature Tₚ, h_{p,b} is the convection heat transfer coefficient between the microwave absorbing particle and the bulk (W/m²−K), σ is the Boltzmann constant and e is the emissivity of the microwave absorbing particles. In most cases, the slurry bulk has a low emissivity and therefore, the radiative portion of the heat transfer may be neglected.

The heat transfer coefficient h_{p,b} is a function of the Nusselt number (Nu) in the slurry phase. A dimensionless number is defined by

$$N {u}_{b} = \frac{{h}_{p , b} d}{{k}_{b}}$$

where d and k_{b} are the characteristic dimension and the thermal conductivity of the bulk, respectively. In one embodiment such as under normal circumstances, the Nusselt number varies as a function of hydrodynamic regimes captured by the Reynolds number (Re) in the slurry phase:

$${Re}_{b} = \frac{{ρ}_{b} v d}{{μ}_{b}}$$

with ρ_{b}, vd and μ_{b} are the density, the characteristic velocity, the characteristic dimension and the dynamic viscosity of the slurry phase, respectively. Therefore, the heat transfer coefficient is a function of the Reynolds number Re and the dimensionless number Nu in the slurry bulk. As a result: h_{p,b}=h_{p,b}(Nu_{b}, Re_{b}).

In order to keep the reactor 12 in a steady state regime, the microwave absorbing particle temperature should be stable, i.e.

$$\frac{d {T}_{p}}{d t} = 0 .$$

Equation 1 can then be rewritten as follows:

$$P - {r}_{A} ( {T}_{p} , {Re}_{b} ) {m}_{p} a Δ {H}_{R} ( {T}_{p} ) - {h}_{p , b} ( {Nu}_{b} , {Re}_{b} ) {m}_{p} a Δ T = 0 \qquad ( Eq . 2 )$$

The temperature gradient ΔT between the microwave absorbing particle and the slurry bulk is then given by:

$$Δ T = \frac{P - {r}_{A} {m}_{p} a Δ {H}_{R} ( {T}_{P} )}{{h}_{p , b} ( {Nu}_{b} , {Re}_{b} ) {m}_{p} a} \qquad ( Eq . 3 )$$

From Equation 3, the person skilled in the art will understand that the temperature gradient ΔT between the surface of the particle and the slurry phase can be adjusted to a desired value by adjusting at least one of the following parameters:
the mass of absorbing particles (mₚ) since reducing the mass of absorbing particles will increase the temperature gradient ΔT;
the specific surface area of the particle (a) since reducing the specific surface area of the particle will increase the temperature gradient ΔT;
the hydrodynamic regime inside the reactor by forcing recirculation with a pump or a bubbling gas (h_{p,b}(Nu_{b}, Re_{b})mₚ) since reducing the heat transfer coefficient between the particle and the slurry phase will increase the temperature gradient ΔT; and
the microwave power P delivered to the reactor 12 since increasing the delivered microwave power will increase the temperature gradient ΔT.

From Equation 2, the person skilled in the art will also understand that it may be possible to change the overall reaction rate by changing the ratio of microwave power to the net surface area of microwave absorbing particles

When the reaction is very fast and when the surrounding fluid has very low thermal conductivity, we have r_{A}mₚaΔH_{R}(Tₚ)»h_{p,b}(Nu_{b}, Re_{b})mₚaΔT. Therefore the reaction is dominant and the thermal loss with the surrounding bulk can be neglected. As a result, it can be assumed that all of the microwave energy is consumed by the reaction and Equation 2 can be rewritten as follows:

$$P - {r}_{A} {m}_{p} a Δ {H}_{R} ( {T}_{p} ) = 0 \qquad ( Eq . 4 )$$

The reaction rate r_{A} can then be written as:

$$\frac{P}{{m}_{p} a} ( \frac{1}{Δ {H}_{R} ( {T}_{p} )} ) = {r}_{A} \qquad ( Eq . 5 )$$

Therefore, increasing the ratio

$$\frac{P}{{m}_{p} a}$$

increases the rate of reaction r_{A}(kg/m2−s).

An alternative way of reaching the same conclusion is by starting from the reaction rate r_{A}(Tₚ, Re_{b}), which follows an Arrhenius expression:

$${r}_{A} = A ( {T}_{p} , {Re}_{b} ) exp ( \frac{- {E}_{A}}{R {T}_{P}} ) f ( {C}_{i} ) \qquad ( Eq . 6 )$$

where A(Tₚ, Re_{b}) is a specific rate constant which is function of the particle temperature and Reynolds number in the slurry bulk and f(Cᵢ) is a kinetic model which is function of the concentration of species i. With all other operating parameters being kept constant, increasing the microwave power P or decreasing the net area of the particles (mₚ a) results in an increase of the particle temperature Tₚ:

$$\frac{P}{{m}_{p} a} = A ( {T}_{p} , {Re}_{b} ) exp ( \frac{- {E}_{A}}{R {T}_{p}} ) Δ {H}_{R} ( {T}_{p} ) f ( {C}_{i} ) + {h}_{p , b} ( {Nu}_{b} , {Re}_{b} ) Δ T \qquad ( Eq . 7 )$$

Since the reaction rate r_{A} varies exponentially with the particle temperature Tₚ, a variation in

$$\frac{P}{{m}_{p} a}$$

will affect particle temperature, which will also affect the reaction rate r_{A}.

In an embodiment in which a temperature control fluid is used for adjusting the temperature of the reactor 12, the temperature gradient ΔT can be controlled via the temperature control fluid.

The reactor 12 is also able to provide very short residence time at the particle temperature by allowing the reaction product to bubble through the bulk slurry phase around the particles after it leaves the surface of the microwave absorbing particle, as illustrated in FIG. 7. In a first step, a reactant particle having the temperature T_{b} of the slurry bulk arrives at the surface of a microwave absorbing particle having a temperature Tₚ which is greater than the temperature of the reactant particle. At step 2, the temperature of the reactant particle increases up to the temperature of the microwave absorbing particle Tₚ and a reaction occurs to generate a reaction product. At step 3, the reaction product is released and its temperature cools down to reach the slurry bulk temperature T_{b}.

Considering that the microwave absorbing particles are at higher temperature than the bulk slurry phase, specific chemical reactions are promoted and occur at faster rates on the surface of the microwave absorbing particles. The reaction products are in a gas phase and escape the particle surface in gas bubbles. Once the product-containing bubbles leave the surface of the hot microwave absorbing particles, the reaction particles immediately cool down by releasing their heat to the slurry phase. The heat transferred to the slurry phase can be expressed as follows (assuming no phase change in the gas):

$${m}_{b} {C}_{p , b} \frac{d {T}_{b}}{d t} = {\dot{m}}_{g} {C}_{p , g} ( {T}_{p} - {T}_{g} ) - {\dot{q}}_{j} \qquad ( Eq . 8 )$$

where mₚ is the mass of the bulk slurry phase, C_{p,b} is the specific heat capacity of the bulk phase (J/kg-K), Tₚ is the temperature of the bulk slurry phase, \dot{m}_{g} is the rate of production of gas (kg/s), C_{p,g} is the specific heat capacity of the gas phase (J/kg-K), To is the temperature of the gas at the outlet of the reactor and \dot{q}_{J} is the heat removal by the jacket. In one embodiment, T_{g} is to be minimized and therefore the desired target is T_{g}=T_{b}.

The above equation is obtained by neglecting the conductive heat transfer between the microwave absorbing particle and the bed, i.e. the surrounding slurry phase as well as the radiative and convective heat loss between the slurry bulk and the reactor 12. It is assumed that most energy transfer is due to the gas release.

In one embodiment, the objective is to maintain the steady state condition in the bulk slurry phase in the reactor 12, i.e.

$$\frac{d {T}_{b}}{d t} = 0 ,$$

in order to maintain the desired temperature gradient between the slurry bulk and the surface of the microwave absorbing particles. In order to achieve this objective, heat has to be removed from the reactor according to the following equation:

$${\dot{q}}_{j} = {\dot{m}}_{g} {C}_{p , g} ( {T}_{p} - {T}_{g} ) \qquad ( Eq . 9 )$$

If no heat is removed from the reactor 12, the following condition occurs:

$${m}_{b} {C}_{p , b} \frac{d {T}_{b}}{d t} = {\dot{m}}_{g} {C}_{p , g} ( {T}_{p} - {T}_{g} ) = 0 \qquad ( Eq . 10 )$$

Equation 10 implies that Tₚ=T_{g}. Since T_{g}=Tₚ for the best case, this implies that without removing heat from the reactor 12, we obtain Tₚ=Tₚ and therefore the gradient between the slurry bulk and the microwave absorbing particles vanishes.

It is therefore required to remove heat from the reactor 12 to maintain the temperature gradient between the particle and the slurry phase to the desired value.

In one embodiment, temperature control fluid may be circulated within the wall of the tubular body 52, as described above.

In the same or another embodiment, water having an adequate temperature or recycled and cooled liquid products generated by the reactor 12 can be injected into the reactor 12 in order to absorb additional energy from the reactor 12 and thereby maintain the temperature gradient.

As described above, temperature control fluid may be circulated within the wall of the tubular body 52 in order to pre-heat the reactor 12 prior and/or during the start-up of the reactor 12. In this case, the temperature control fluid may pre-heat the wall of the tubular body 52 at the reaction temperature to prevent slurry phase to solidify when fed into the reactor 12. For example, if the slurry phase is composed of molten plastic with a melting temperature around 225° C., the reactor 12 may be pre-heated at a temperature above the 225° C.

In one embodiment, the cooling of the wall of the tubular body 52 of the reactor 12 ensures that no hot spot will be created in the reactor 12 and cause mechanical stress on the reactor's components. Since microwave heating can concentrate high amount of energy, it may be important to ensure that hot spots have a limited impact on the reactor integrity.

In an embodiment in which the reactor 12 comprises the gas outlet 86 for allowing gas to exit the reactor 12, a gas flow sensor may be operatively connected to the gas outlet 86 to track the rate of production of gas (\dot{m}_{g}) which is a direct measure of the reaction rate. The gas flow rate may be any adequate device configured for measuring the flow rate of a gas such as a pitot tube or a Venturi gas flow meter.

In an embodiment in a temperature control fluid is circulated within the wall of the reactor 12, at least one temperature sensor and at least one flow sensor may be used for determining the heat flux captured by the temperature control fluid during the reaction (\dot{q}_{J}). Using the heat balance presented above, this temperature control fluid may allow for controlling the temperature of the microwave absorbing particles to ensure optimum reaction conditions. The temperature of the microwave absorbing particles can be determined using the heat flux measurement (\dot{q}_{J}) and the gas flow rate (\dot{m}_{g}) according to the following equation:

$${T}_{p} = ( \frac{1}{{\dot{m}}_{g}} ) \frac{{\dot{q}}_{j}}{{C}_{p , g}} + {T}_{b} \qquad ( Eq . 11 )$$

In an embodiment in which the reactor 12 is provided with a circular microwave inlet 58 connected to the microwave coupler 14, backflow of the slurry in the waveguide/coupler using an interface sealed by a high temperature seal may be prevented. In one embodiment, the diameter d of the microwave inlet 58 satisfies the following equation: d≥c/f where c is the speed of light and f the frequency of the microwaves. Typically for standard 915 MHz microwaves, the diameter of the reactor is d≥0.32 m. In one embodiment, the circular shape of the microwave inlet 58 allows for better sealing with a circular seal, which would be more complicated if the inlet 58 would have a non-circular shape. The circular shape of the interface also allows for a reduction of the surface electrical field to reach values below the electrical breakdown of the material touching the interface. For example, rectangular shapes may yield higher electrical field values on the interface and cause arcing and/or plasmas, and may ultimately yield to thermal shock on the interface followed by breakdown.

In one embodiment, the microwave inlet 58 penetrates inside the reactor 12 and leaves a certain zone 98 in front of the interface that is designed to prevent accumulation of solids. This microwave inlet 58 is then immerged inside the slurry phase below the fill level 66 to ensure isothermal conditions on the surface of the microwave coupler interface. In one embodiment, an immerged microwave inlet 58 positioned below the fill level 66 is preferred to an inlet located above the slurry phase as it avoids bubbles from entraining microwave absorbing particles onto the interface of the coupler and therefore prevents thermal shocks. When the coupler interface is above the slurry phase in the gas phase zone and bubbles of liquid entraining absorbing particles hit the surface of the interface of the coupler, the microwave absorbing particles may absorb more heat by being closer to the microwave source and the entrained liquid may decompose following the normal reaction path, but upon exhaustion of the liquid entrained with the bubbles, the microwave absorbing particles may rise suddenly in temperature because no more reacting material surrounds them. This may create a thermal shock for the microwave coupler interface and cause systematic failures of the interface.

In one embodiment, submerging the interface of the coupler below the fill level 66 in the reacting slurry phase may ensure that when the microwave absorbing particles hit the coupler's interface, the microwave absorbing particles are substantially always surrounded by reacting material and therefore the temperature of the microwave absorbing particles hitting the coupler's interface will not rise suddenly and cause thermal shocks on the interface.

In one embodiment, the angle of the microwave inlet 58 is chosen so as to avoid accumulation of microwave absorbing particles and gas bubbles onto the surface of the coupler interface. The microwave inlet 58 may be orthogonal to tubular body 52 so that the coupler interface surface is parallel to the tubular body 52, which minimizes the risk of particle and bubble accumulation.

In one embodiment, the closer the interface is from the slurry phase, the easier is the tuning of the system. Furthermore, since high microwave energy density can lead to arcing, having the interface closer to the slurry minimizes the high energy density zone. Therefore it may be important to minimize the coupler intrusion zone 98. In some embodiments, the coupler intrusion zone 98 is designed to prevent accumulation of solids in front of the interface of the coupler. For example, a chamfer of 45° around the interface inlet may be enough to prevent accumulation of solids around the interface of the coupler.

In one embodiment, the coupler can be flush with the reactor inner wall in the coupler intrusion zone 98 in order to eliminate surfaces where microwave absorbing particles and gas bubbles may accumulate and create hot spots.

In one embodiment, the reaction may produce solid by-products that are not devolatilized. In addition, the feed composition may cause accumulation of material which may build-up in the reactor. Therefore, to prevent accumulation of non-soluble solids in the reactor, a filtration or centrifugation system may recirculate the slurry to remove solid particulates. The slurry extraction port 84 on the reactor 12 contains a screen that prevents the microwave absorbing particles in suspension in the slurry phase from being extracted and removed by the filter. It should be understood that the screen mesh size should be smaller than the size of the microwave absorbing particles in suspension in the bulk. In one embodiment, the reactor diameter may be at most equal to about 18 inches and the diameter of the gas outlet 86 may be limited to about 3 inches to promote solid by-product particle entrainment with the gas out of the reactor 12.

In one embodiment, the reaction may create by-products soluble in the slurry phase. In addition, the feed composition may include material that are soluble in the slurry phase and do not devolatilize during the chemical reaction which may build-up in the reactor 12. In order to prevent accumulation of soluble components in the reactor, a purge stream can draw a constant flow of slurry phase to control the level of soluble contaminants in the reactor. This purge line may also be used to empty the reactor 12 when desired. It may also be used to control residence time of the slurry phase if a specific residence time is needed.

In an embodiment in which the fill level of slurry phase is to be maintained in the reactor 12, the level of the slurry phase, i.e. the position of the top surface of the slurry phase, may be determined by measuring the differential pressure between the top portion of the reactor 12 and the bottom portion of the reactor 12.

In one embodiment, the gases produced by the reaction are cooled down in a stage condensation system to perform a selective condensation of less volatile fractions in a first stage of the condensation system and a further condensation of more volatile fractions in a second stage of the condensation system. It should be understood that the number of stages in the condensation system may vary. In one embodiment, the selective fractions can be recycled into the reactor 12 to provide longer residence time or multiple passes in the reactor 12 and increase overall yields of the desired products.

In one embodiment, the reactor comprises a partial reflux system which may be installed on top of the reactor 12 to reflux back the heavier fractions in the gases more easily in the reactor.

In one embodiment, the reactor 12 is equipped with various nitrogen purge to remove air entrapped in the reactor before starting and in the coupler to prevent accumulation of flammable gases in the waveguide.

In one embodiment, the reactor is equipped with an overpressure protection system. In one embodiment, the reactor is rated for 100 psig at operating temperature to allow the use of smaller venting devices.

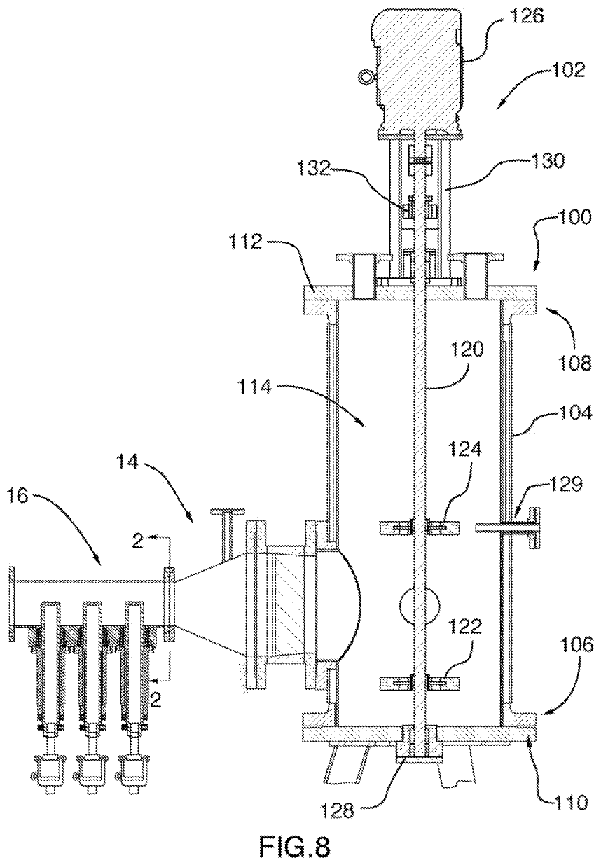

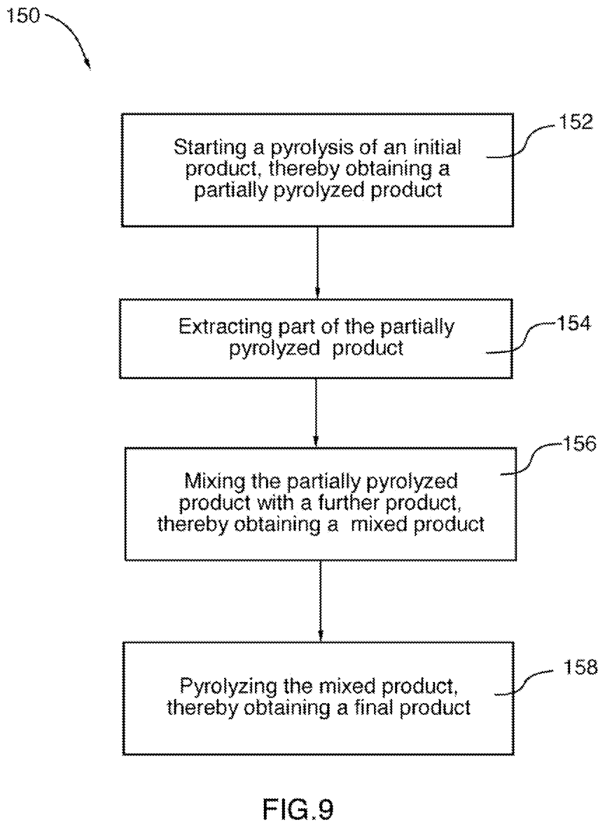

As described above, the reactor may be provided with an agitator device. FIG. 8 illustrates one embodiment of a reactor 100 provided with a mechanical agitator device 102. The reactor 100 is configured for performing chemical and/or physical reactions therein under the action of microwave energy and its structure and architecture is similar to those of reactor 12.

The reactor 100 comprises a tubular body 104 extending along a longitudinal axis between a first or bottom end 106 and a second or top end 108, a bottom body or floor 110 and a top body or cover 112. The tubular body 104 defines a cavity 114 in which the product to be pyrolyzed is to be received. The bottom body 110 is secured to the bottom end 106 of the tubular body 104 and has a size that is at least equal to the cross-sectional size of the bottom end of the cavity 114 so as to close the bottom end 106 of the tubular body 104. The top body 112 is secured to the top end 108 of the tubular body 104 and has a size that is at least equal to the cross-sectional size of the top end of the cavity 114 so as to close the top end 108 of the tubular body 104. When the bottom and top bodies 110 and 112 are secured to the tubular body 104, the assembly form an enclosure in which the product to be pyrolyzed is placed.

The agitator device 102 comprises a shaft 120, a first pair of blades 122, a second pair of blades 124 and a motor 126. The first and second pairs of blades 122 and 124 are secured to the shaft at different positions along the length thereof. The shaft 120 extends longitudinally through reactor 100 and the motor 126 is mounted on the top of the top body 112 of the reactor 100. The bottom end of the shaft is rotatably secured to the bottom body 110 and the top end of the shaft 120 is operatively connected to the motor 126 so that an actuation of the motor 126 triggers a rotation of the shaft 120 about its longitudinal axis. The rotation of the shaft 120 triggers a rotation of the blades 122 and 124 in order to agitate the slurry phase present into the reactor 100.

In the illustrated embodiment, the bottom body 110 and the top body 112 are each provided with a respective shaft receiving aperture. The bottom end of the shaft 120 extends though the shaft receiving aperture of the bottom body 110 and is rotatably secured to the bottom body 110 via a securing body 128. The top portion of the shaft 120 extends through the shaft receiving aperture present in the top body 112 and the top end of the shaft 120 is operatively secured to the motor 126. It should be understood that at least one first seal may be positioned within each shaft receiving aperture of the bottom and top bodies 110 and 112 to sealingly connect the shaft 120 to the bottom and top bodies 110 and 112 so that the cavity 114 be hermetically closed and no fluid may exit the reactor 100 via the shaft receiving apertures of the bottom and top bodies 110 and 112.

In one embodiment, the position of the first pair of blades 122 along the length of the shaft 120 is chosen so that when the shaft 120 is secured to the reactor 100 the blades 122 are in physical contact with the slurry phase present in the reactor 100. Similarly, the position of the second pair of blades 124 along the length of the shaft 120 is also chosen so that the blades 124 are in physical contact with the slurry phase present in the reactor 100. In an embodiment, the reactor 100 is provided with a fill level representing a desired level of product or a minimal level of product within the reactor 100. In this case, the position of the first and second blades 122 and 124 along the length of the shaft 120 may be chosen so that the first and second blades be located below the fill level, i.e. between the fill level and the bottom body 110.

While for the reactor 12 the inlet 74 for injecting material to be pyrolyzed into the reactor 12 is located on the bottom body 54, the reactor 100 comprises an inlet 129 located on the wall of the tubular body 104 for injecting material into the reactor 100. In an embodiment in which the reactor 100 is provided with a fill level, the position of the inlet 129 may be chosen to be below the fill level.

It should be understood that the agitator device 102 may comprise additional components. For example and as illustrated in FIG. 8, the agitator device 102 may comprise a tubular body 330 secured to the top face of the top body 112 around the shaft receiving aperture and extending away from the top body 112. The motor 126 is secured to the top end of the tubular body 330. The shaft 120 extends inside the cavity defined by the tubular body 330 so that its top end be connected to the motor 126. For example, the agitator device 102 may further comprise at least one bearing 332 positioned within the tubular body 330 for receiving the shaft therein.

It should be understood that the number, shape and position along the length of the shaft 120 for the blades 122 and 124 may vary. For example, the blades 122 or the blades 124 may be omitted.

In another example, the agitator device 102 may comprise a single blade secured to the shaft 120. In the following there is described a method 150 for pyrolyzing a product. The method may be performed using any adequate pyrolyzing reactor such a microwave pyrolysis reactor. However, it should be understood that the method 150 is not limited to be used with a microwave pyrolysis reactor.

At step 152, the pyrolysis of a product is started, thereby obtaining a partially pyrolyzed product. The product is introduced into a pyrolysis reactor and heated to start a pyrolysis process. For example, the product to be pyrolyzed is introduced into a microwave pyrolysis reactor such as reactor 12 or 100 and microwaves are generated and coupled into the microwave pyrolysis reactor to start the pyrolysis process.

At step 154, part of the partially pyrolyzed product is extracted from the reactor. At step 156, the extracted partially pyrolyzed product is mixed with additional product to be pyrolyzed, thereby obtaining a mixed product. For example, the extracted product and the additional product to be pyrolyzed may be injected into a mixing tank. The mixed product is then pyrolyzed at step 158 to obtain a final product. The mixed product is injected into the pyrolysis reactor to be pyrolyzed by heating.

In one embodiment, the method 150 further comprises heating the mixture of partially pyrolyzed product and product to be pyrolyzed to a desired temperature during the mixing step 156. The desired heating temperature may be chosen as a function of a desired viscosity for the mixed product.

In one embodiment, the pyrolysis method 100 uses microwaves to perform the pyrolysis process and the product to be pyrolyzed comprises a polymer. The method 100 then allows for improving the performance of the microwave pyrolysis process.

In one embodiment, the method 150 further comprises a step of filtering the extracted partially pyrolyzed product after the extraction step 154 and before the mixing step 156 in order to remove contaminants for example.

Existing polymer dissolution systems use a solvent to selectively dissolve a polymer. The liquid solution is filtered to remove undissolved matter (e.g. contaminants). The filtrate is recovered and the solvent is stripped to precipitate the polymer that is recovered. The solvent can dissolve some contaminants that can precipitate with the polymer. These contaminants need to be removed by some other method from the polymer. Alternatively the contaminants may be kept with the polymer but this affects the end use of the recovered polymer. For example, it may prevent the recovered polymer from being used for food grade applications.

During the solvent stripping step, contaminants can also be stripped and mixed with the recovered solvent. The solvent then requires to be purified using a distillation column for example.

When using a microwave pyrolysis reactor without the mixing step 156 of method 100, polymer is injected into the microwave pyrolysis reactor to undergo depolymerisation. The high viscosity of the injected polymer may lead to zones of high viscosity and high viscosity gradients in the slurry phase reactor. The high viscosity may result in mass and heat transfer limitations that lead to hot spots and thermal shock at the microwave coupler. Thermal shocks may lead to failure of the microwave coupler. The use of method 150 in which preconditioning the polymer by solubilizing the polymer in a solvent resulting from the pyrolysis process reduces the viscosity of the injected polymer thereby minimizing the risk of hot spots in the slurry phase present in the reactor and improving the quality of the end product. Furthermore, the lower viscosity allows the use of cheaper equipment for slurry injection and filtration.

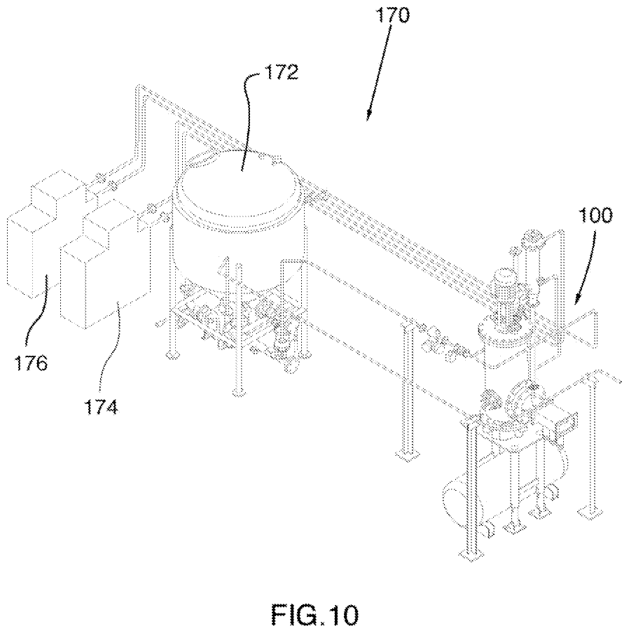

FIG. 10 illustrates one exemplary pyrolysis system 170 for performing the method 150. The pyrolysis system 170 comprises the microwave reactor 100, a mixing tank fluidly connected to the reactor 100, a first source of thermal fluid 174 and a second source of thermal fluid 176. A first fluidic connection extends between the microwave reactor 100 and the mixing tank 172 for extracting part of the slurry phase contained in the microwave reactor 100 and injecting the extracted slurry phase into the mixing tank 172. A second fluidic connection also extends between the microwave reactor 100 and the mixing tank 172 for injecting the mixture contained in the mixing tank 172 into the microwave reactor 100.

The first source of thermal fluid is used for delivering a thermal fluid heated to a desired temperature to the mixing tank 172 and thereby controlling the temperature of the wall of the mixing tank 172. The second source of thermal fluid is used for delivering a thermal fluid heated to a desired temperature to the microwave reactor 100 and thereby controlling the temperature of the wall of the microwave reactor 100.

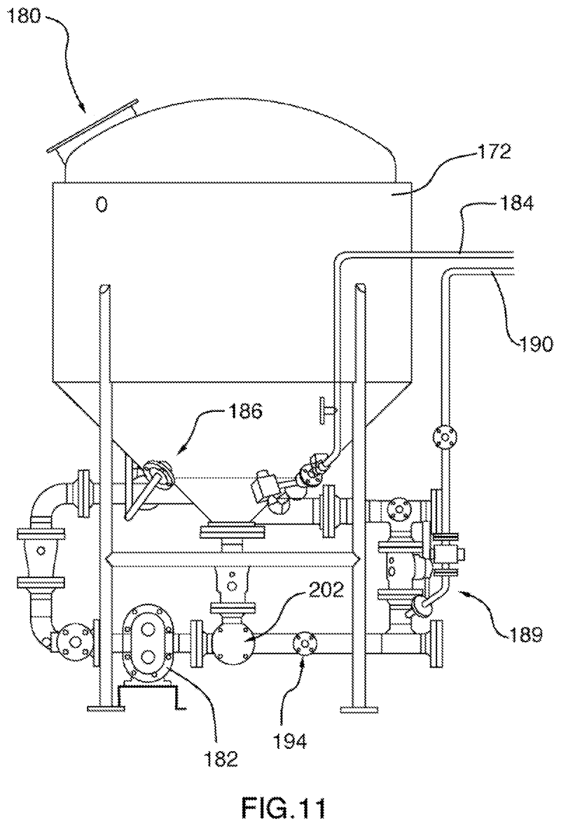

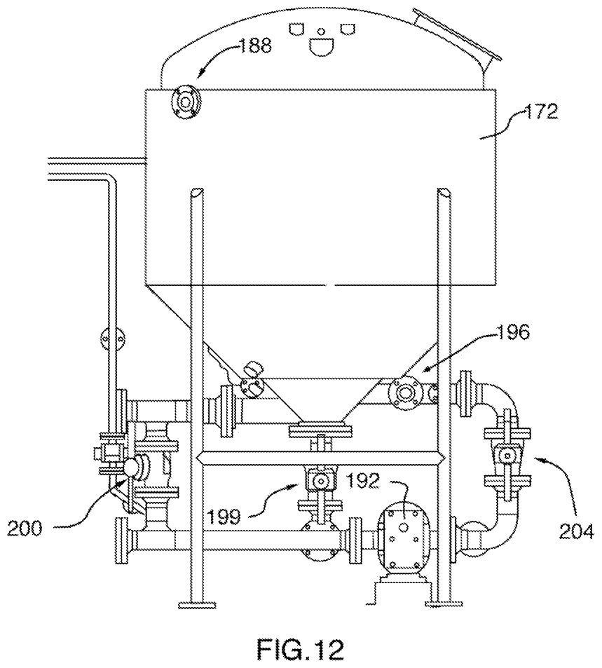

FIGS. 11 and 12 illustrate the mixing tank 172 and the fluidic connections between the mixing tank 170 and the microwave reactor 100.

It should be understood that the use of the microwave reactor 100 in the system 170 is exemplary only. For example, the reactor 12 could be used in the system 170. The mixing within the tank 172 is promoted using an agitator (not shown) and a recirculation pump 182. Part of the partially pyrolyzed product contained within the reactor 100 is injected into the mixing tank 172 via the fluidic connection 184. The product to be pyrolyzed is injected into the mixing tank 172 through port 180. The partially pyrolyzed product and the product to be pyrolyzed are mixed together thanks to the agitator. The mixing tank 172 is jacketed (i.e. it comprises a double wall in which fluid may flow) and insulated. A thermal fluid coming from the source 174 is circulated through the mixing tank jacket via ports 186 and 188 to control the temperature of the mixture within the mixing tank 172. The flow of partially pyrolyzed product coming from the reactor 100 may be filtered to remove particles and/or contaminants.

The mixed product is filtered via filter 189 to remove undissolved and solid contaminants prior to be injected into the reactor 100 via the fluidic connection 190. It should be understood that the filter casing volume and mesh size is selected based on the mass fraction and physical size of the contaminants to be filtered.

In one embodiment, the slurry viscosity in the mixing tank is measured by monitoring the electrical power consumed by the agitator motor (not shown) and the recirculation pump motor 192. Slurry samples may also be extracted through port 194 for off-line viscosity measurements.

An in-line viscosity measurement device can also be installed on the recirculation pipes to measure slurry viscosity in-line.

In one embodiment, the level of product within the mixing tank 172 is measured by measuring the hydrostatic pressure at port 196. The injection can be done by partially closing valves 198 and 200 to build a pressure downstream of the recirculation pump 182 and upstream of the reactor feed connection 190. In another embodiment, the injection can also be done using a separate pump connected to the connection 190.

The mixing tank 172 can be completely emptied by opening drain port 202. Alternatively, the mixing tank 172 may be emptied by operating the recirculation pump 182 in a reverse mode, closing the valve 204 and draining through port 200.

For example, the system 170 may be used for pyrolyzing polystyrene. In this case, polystyrene is mixed with styrene oligomers. The styrene oligomers are generated in the reactor 100 injected into the mixing tank 172 at a temperature of about 250-300° C. The polystyrene is mixed and dissolved in the styrene oligomers slurry. The temperature of the slurry within the mixing tank 172 is maintained at a temperature of about 150° C., which is above the styrene oligomers' fusion temperature (i.e. 80-100° C.). The temperature is also controlled to have a fast polystyrene dissolution rate and the desired dissolution selectivity. The mass flow rate of styrene oligomers from the depolymerisation reactor to the mixing tank is fixed and is filtered to remove particles (carbon black particles and others) with a centrifuge and/or filter upstream of the mixing tank. The mass flow rate of polystyrene to the mixing tank is controlled to maintain a specific slurry viscosity in the mixing tank and a specific rate of increase of slurry viscosity.

The mixing tank agitator and recirculation pump design and speed are set to eliminate dead zones and promote a uniform mixture.

Polystyrene is injected in the mixing tank at a rate to maintain a specific slurry viscosity and rate of increase in viscosity. The injection can be done manually or automatically with a feeding system. The injected polystyrene can be in solid and melt form.

The thermal fluid is used to maintain the slurry temperature above the styrene oligomers fusion temperature so that they remain liquid. The slurry temperature is also controlled to increase polystyrene dissolution rates and adjust the dissolution selectivity.

In one embodiment, the slurry in the mixing tank is injected in the reactor 100 at a rate that is controlled to maintain a fixed liquid level in the mixing tank 172.

While the above description refers to at least one absorbing particle that is free of moving within the slurry phase in order to interact with the microwaves and heat the slurry phase, the absorbing particles may be replaced by at least one body made of microwave absorbing material and having a fixed position within the reactor. It should be understood that the number, shape, dimension and position of the absorbing body may vary. For example, at least one absorbing rod may be secured within the reactor at a fixed position. The proximal end of the absorbing rods may be secured to the bottom body within the reactor and extend longitudinally towards the top body of the reactor. The length of the absorbing rods may be chosen so that the distal end of the absorbing rods be aligned with the fill level of the reactor or located below the fill level of the reactor.

In one embodiment, the absorbing body is spaced apart from the coupler so that no hot spot may damage the coupler interface.

In one embodiment, the use of a fixed position absorbing body may decrease the agitation within the slurry phase and allow for higher reaction temperature to be reached.

In one embodiment, the microwave absorbing particles are made of carbon black, graphite or silicon carbide. In another embodiment, the microwave absorbing particles may be replaced by a fluid such as water.

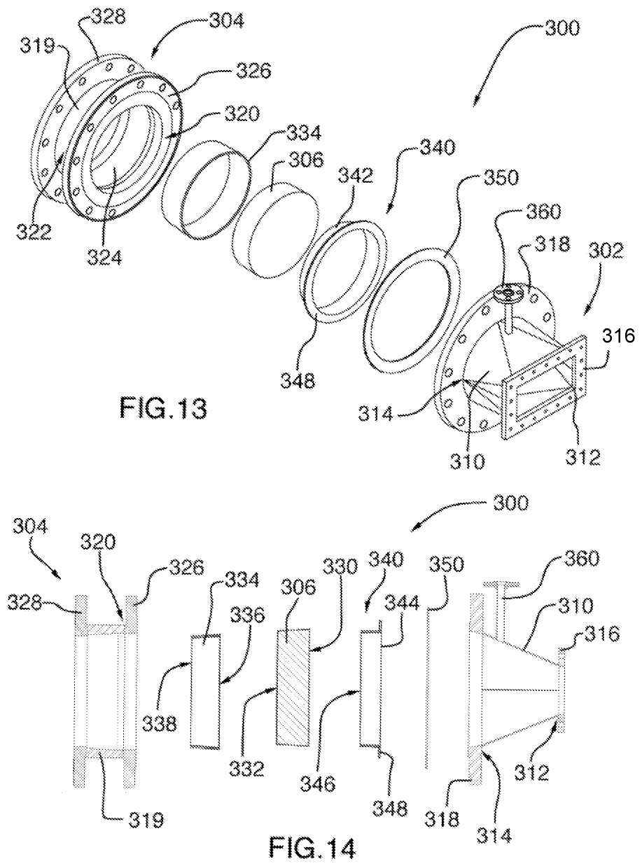

Referring back to FIG. 1, the system 10 comprises a coupler 14 for injecting the microwaves coming from the tuner 16 into the reactor 12. FIGS. 13-18 illustrate different embodiments for a coupler such as coupler 14.

In conventional microwave pyrolysis systems, a rectangular waveguide (i.e. a waveguide extending a longitudinal axis and of which the cross-section orthogonal to the longitudinal axis has a rectangular shape), such as a standard WR975 rectangular waveguide, is usually used for operatively connecting the microwave generator to the reactor and propagate microwaves into the reactor. In some of the prior art microwave pyrolysis systems, there is no physical interface between the cavity defined within the reactor and the rectangular waveguide. The absence of any physical interface makes such microwave pyrolysis systems inadequate for performing chemical reactions that involve multiphase environments (solid, gas and/or liquid) that need to be contained inside the cavity. Because of the absence of any physical barrier, the solid, gas and/or liquid may interact with the microwaves to produce hot spots, arcing (hot plasma) and waveguide failure. Since the waveguide is characterized by a high microwave power density and high electric field, the tendency towards arcing and hot spot production is high inside the waveguide.

Furthermore, the maximum electrical field intensity for a rectangular waveguide is located along the middle of its long wall. Accumulation of microwave absorbing material in the waveguide leads to the production of hot spots on the internal wall of the and results in the melting of the waveguide surface.

FIG. 13-15 illustrate a first embodiment for a coupler 300 for connecting the reactor 12 to the tuner 18, a microwave waveguide or a microwave source. The coupler 300 may overcome at least some of the above-identified drawbacks of at least some prior art microwave pyrolysis systems.

The coupler 300 comprises C connectable to a waveguide or a microwave generator, a connection body 304 securable to the mode conversion body 302 and a reactor such as reactor 12, and a barrier body 306 insertable into the connection body 304 for isolating the mode conversion body 302 from the reactor.

The mode conversion body 302 comprises a hollow and tapered body 310 extending along a longitudinal axis between a first end 312 and a second end 314, a first end plate 316 secured at the first end 312 of tapered body 310 and a second end plate 318 secured at the second end 314 of the tapered body 310.

The tapered body 310 defines a cavity which extends through its whole length from the first end 312 to the second end 314. The first end 312 of the tapered body 310 has a rectangular shape so that the cavity at the first end 312 is also provided with a rectangular shape. The second end 314 of the tapered body 310 has a circular shape so that the cavity at the second end 314 is also provided with a circular shape. The body 310 is tapered so that the cross-sectional size of the cavity defined therein increases from the first end 312 of the body 310 to the second end 314 and the shape of the tapered body 310 passes from a rectangular shape at its first end 312 to a circular shape at its second end 314.

A first rim projects outwardly from the first end 312 of the tapered body 302 to form the first end plate 316. As a result, the first end plate 316 surrounds the perimeter of the first end 312 of the tapered body 302 and is provided with a square shape having a square aperture. The plate 312 is designed so as to be secured to a microwave generator, a microwave waveguide or a microwave tuner. For example and as illustrated, the plate 316 may be provided securing holes for securing purposes.

Similarly, a second rim projects outwardly from the second end 314 of the tapered body 302 to form the second end plate 318. As a result, the second end plate 318 surrounds the perimeter of the first end 314 of the tapered body 302 and is provided with a circular shape having a circular aperture. The plate 318 is designed so as to be secured to the connection body 304. For example and as illustrated in FIG. 13, the plate 318 may be provided with securing holes for receiving bolts or screws therethrough.

It should be understood that the shapes of the first and second end plates 316 and 318 are exemplary only and may vary as along as the first end plate 316 allows the coupler 300 to be secured to a waveguide, a tuner or a microwave generator, and the second end plate 318 allows the coupler 300 to be secured to the connection body 304. For example, while the first and second end plates 316 and 318 extends substantially orthogonally to the longitudinal axis of the tapered body, it should be understood that other embodiments may be possible.

The connection body 304 comprises a generally tubular body 319 which extends along a longitudinal axis between a first end 320 and a second end 322. The tubular body 319 defines an internal cavity which extends along the whole length of the connection body 304 between the first and second ends 320 and 322. The internal surface of the tubular body 319 surrounding the internal cavity is shaped and sized so as to receive the barrier body 306 therein.

The internal wall 324 of the tubular body 319 is tapered so that the internal wall 324 and the internal cavity are each provided with a truncated conical shape. In the illustrated embodiment, the diameter of the internal wall 324 (or the diameter of the cavity) at the first end 320 is greater than that of the internal wall 324 (or of the cavity) at the second end 322. However, the person skilled in the art would understand that other configurations may be possible. For example, the diameter of the internal wall 324 may be constant along the length of the tubular body 319. In another example, the diameter of the internal wall 324 at the first end 320 is less than that of the internal wall 324 at the second end 322. In the illustrated embodiment, the external diameter of the tubular body 319 is constant along the length thereof.

In one embodiment, the internal diameter of the tubular body 319 at the second end 322 is substantially equal to the diameter of the aperture of the reactor through which microwaves are to be propagated into the reactor (such as aperture 84).

In one embodiment, the internal diameter of the tubular body 319 at the first end 320 thereof is substantially equal to the internal diameter of the tapered body 310 at the second end 314 thereof.

While in the illustrated embodiment, the diameter of the internal wall 324 has a constant diameter along a given section adjacent to the first end 320 of the tubular body before decreasing towards the second end 322, it should be understood that other configurations may be possible. For example, the diameter of the internal wall 324 may be continuously decreasing from the first end 320 to the second end 322 of the tubular body 319.

The connection body 304 further comprises a first annular plate 326 secured to the first end of the tubular body 319 and a second annular plate 328 secured to the second end of the tubular body 319. The first annular plate 326 comprises a circular aperture extending therethrough and the diameter of the circular aperture is substantially equal to the diameter of the cavity defined by the tubular body 319 at the first end 320 thereof. The second annular plate 328 also comprises a circular aperture extending therethrough and the diameter of the circular aperture is substantially equal to the diameter of the cavity defined by the tubular body 319 at the second end 322 thereof. The plate 328 is designed so as to be secured to a microwave reactor. For example and as illustrated, the plate 328 may be provided with holes extending therethrough for receiving therein bolts or screws. Similarly, the plate 326 is designed so as to be secured to the plate 318 of the body 302, and may also be provided with apertures extending therethrough for receiving bolts or screws.

While the plates 326 and 328 each have an annual shape, it should be understood that the plates 326 and 328 may have any other adequate shape as long as they each comprise their respective aperture therethrough.

Referring back to FIGS. 13 and 14, the barrier body 306 is sized and shaped so as to be received within the cavity of the tubular body 319. The barrier body extends longitudinally between a first end 330 and a second end 332. The barrier body 306 is provided with a truncated conical shape so that its diameter decreases from the first end 330 to the second end 332. It should be understood that the barrier 306 is used for preventing material present in the reactor to enter or propagate into the coupler 300.

In the illustrated embodiment, the coupler 300 further comprises a seal 334 to be positioned within the cavity of the tubular body 319 between the internal wall of the tubular body 319 and the barrier body 306. The seal 334 has a truncated conical shape, i.e. a generally tubular shape with an internal varying diameter and an external varying diameter. The seal 334 extends a longitudinal axis between a first end 336 and a second end 338 and defines a barrier receiving cavity which extends through the whole length of the seal 334 from the first end 336 to the second end 338. The external and internal diameters of the seal 334 decrease from the first end 336 towards the second end 338.

The external diameter of the seal 334 substantially matches the internal diameter of the tubular body 319 so that the seal 334 may snuggingly fit into the tubular body 319 and the internal diameter of the seal 334 substantially matches the diameter of the barrier body 306 so that the barrier body 306 may snuggingly fit into the seal 334.

In the illustrated embodiment, the length of the barrier body 306, i.e. the distance between the first end 330 and the second end 332, is shorter than that of the seal 334. However, the person skilled in the art would understand that other configurations may be possible. For example, the length of the barrier body 306 may be substantially equal to that of the tubular body 319.

In the illustrated embodiment, the coupler 300 further comprises a backup body 340 which comprises a tubular portion 342 which extends between a first end 344 and a second end 346 along a longitudinal axis. The external diameter of the tubular portion 342 is substantially equal to the internal diameter of the annular plate 326. The backup body 340 is further provided with a flange 348 which extends radially and outwardly from the first end 344 of the tubular portion 342. The flange 348 is substantially orthogonal to the longitudinal axis of the backup body 340.

The length of the backup body 340, i.e. the distance between the first end 344 and the second end 346 of the tubular portion 342, is chosen so that when the seal 334 is inserted into the connection body 304, the barrier body 306 is inserted into the seal 334 and the backup body 340 is inserted into the connection body 304 behind the barrier body 306, the second end 346 of the tubular portion 342 abuts against the first end 336 of the barrier body 306 and the flange 348 of the backup body 340 abuts against the annular plate 326 of the connection body 304. When inserted into the connection body 304, the backup body 340 extends through the first annular plate 326 and through the section of the section of the tubular body 319 having a constant internal diameter adjacent to the first end 320 of the tubular body 319.

In one embodiment, the coupler 300 further comprises an annular gasket 350 to be inserted between the annular pate 326 of the connection body 304 and the end plate 318 of the mode conversion body 302.

In one embodiment, the seal 330 may be omitted. In this case, the diameter of the barrier body 306 matches the internal diameter of the tubular body 319 so that the barrier 306 may snuggingly fit into the tubular body 319.

In one embodiment, the plates 316, 318, 326 and 328 are each provided with holes extending along their perimeter for securing the mode conversion body 302 to the connection body 304, the connection body 304 to a reactor and the mode conversion body 302 to a tuner, a waveguide or a microwave generator.

It should be understood that the backup body 340 is optional and may be omitted.

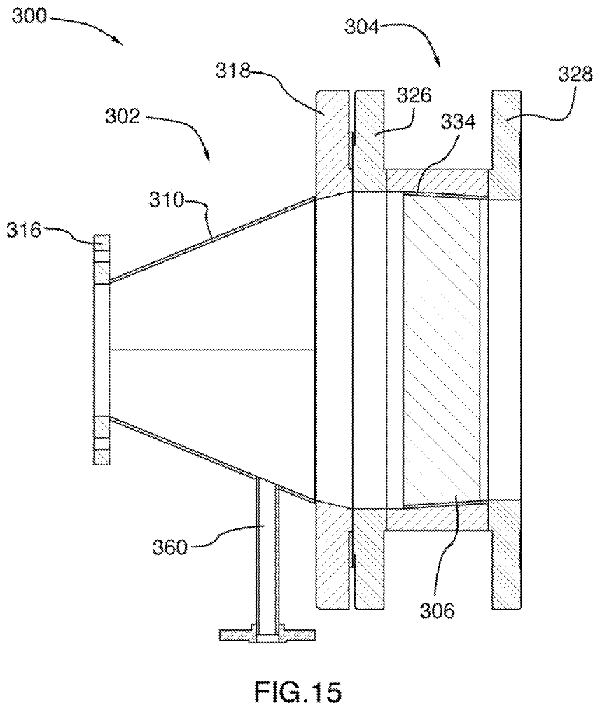

FIG. 15 illustrates the coupler 300 once assembled with the backup body 340 omitted. The seal 334 is positioned into the tubular body 319 of the connection body 304 so that the end 338 of the seal 334 be substantially aligned or coplanar with the end 322 of the tubular body 319. The barrier body 306 is located inside the seal 334 so that the end 330 of the barrier body 306 be substantially aligned or coplanar with the end 336 of the seal 334. The backup body 340 is inserted into the connection body 304 behind the barrier body 306 so that the barrier body 306 be positioned between the annular plate 328 and the backup body 340. Once positioned, the end 346 of the backup body 340 abuts against the end 330 of the barrier body and the flange 348 of the backup body 340 abuts against the annular plate 326 of the connection body 304.

The gasket 350 is positioned between the plate 318 of the mode conversion body 302 and the annular plate 326 of the connection body 304. The mode conversion body 302 and the connection body 304 are secured together using bolts and nuts. Each bolt is inserted through a respective hole of the plate 318 of the mode conversion body 302 and a respective hole of the annular plate 326 of the connection body 304.

In operation, the coupler 300, i.e. the mode conversion body 302 of the coupler 300, is operatively connected directly or indirectly to a microwave generator. For example, the plate 316 of the mode conversion body 302 may be secured to a tuner such as tuner 14 so that the mode conversion body 312 may receive microwaves from the tuner. In another example, the plate 316 of the mode conversion body 302 may be secured to a waveguide so that the mode conversion body 312 may receive microwaves from the waveguide. In a further example, the plate 316 of the mode conversion body 302 may be secured to a microwave generator so that the mode conversion body 312 may receive microwaves therefrom.

The coupler 300 is further operatively connected to the reactor in which pyrolysis is to occur, such as reactor 12. The annular plate 328 is secured to the reactor so as to propagate microwaves therein.

The mode conversion body 302 receives microwaves at its end 312 and the microwaves propagate within the cavity defined by the tapered body from the rectangular end 312 towards the circular end 314. During the propagation within the cavity, the propagation mode of the microwaves changes due to the change of geometry of the tapered body 330 from a rectangular shape at the end 312 to a circular shape at the end 314. More specifically, the propagation mode passes from a transverse (TE) mode at the end 312 to an linearly polarized (LP) mode at the end 314. The then converted LP mode microwaves then propagate through the barrier body 306 and into the reactor to which the connection body 304 is secured.

While the above description refers to bolts and nuts for removably securing the mode conversion body 302 and the connection body 304 together, it should be understood that any adequate securing means for removably securing the mode conversion body 302 and the connection body 304 together may be used.

While in the illustrated embodiment the mode conversion body 302 and the connection body 304 are independent from one another, the mode conversion body 302 and the connection body 304 could be integral to form a single piece. In this case, the plates 318 and 326 may be omitted so that the end 314 of the tapered body 330 be connected to the end 320 of the tubular body 319.

In one embodiment, the coupler 300 may be used when the pressure within the reactor is less than the surrounding pressure such as the pressure within the mode conversion body 302. In this case, the difference between the pressure within the reactor and the pressure within the mode conversion body 302 creates a force exerted on the barrier body 306 towards the reactor, i.e. towards the annular plate 328, which further pushes the barrier body 306 against the internal wall of the seal 334 and the seal 334 against the internal wall of the tubular body 319, thereby improving the sealing of the coupler 300.

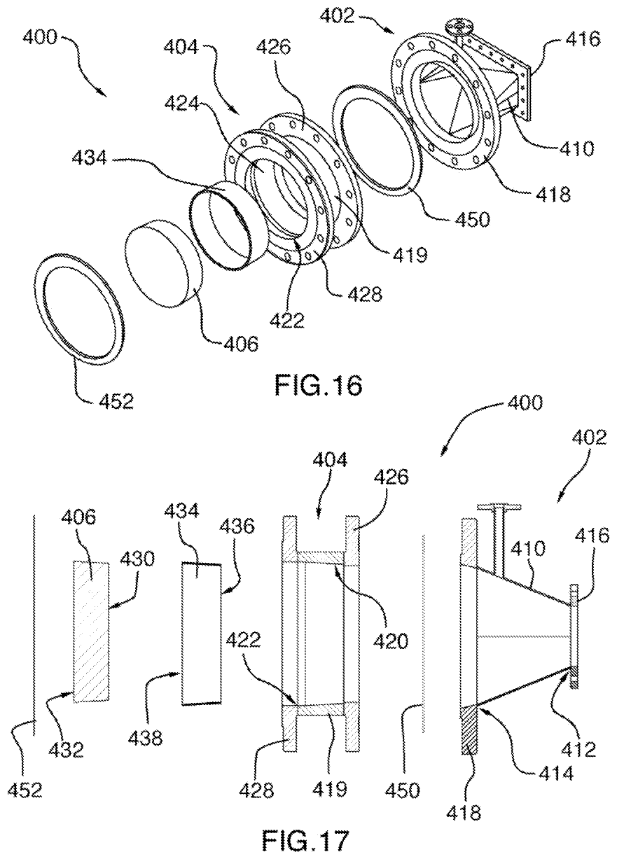

FIGS. 16-17 illustrate another embodiment for a coupler 400 to be secured to a microwave reactor which may be used when the pressure within the reactor is greater than the pressure within the coupler 400 for example.

The coupler 400 may be operatively connected to a microwave pyrolysis reactor such as reactor 12 at one end, and to a tuner, a waveguide or a microwave generator at another end for propagating microwaves into the reactor.

The coupler 400 comprises a mode conversion body 402 connectable to a waveguide or a microwave generator, a connection body 404 securable to the mode conversion body 402 and the reactor, and a barrier body 406 insertable into the connection body 404 for isolating the mode conversion body 402 from the reactor.

The mode conversion body 402 comprises a hollow and tapered body 410 extending along a longitudinal axis between a first end 412 and a second end 414, a first end plate 416 secured at the first end 412 of tapered body 410 and a second end plate 418 secured at the second end 414 of the tapered body 410.

The tapered body 410 defines a cavity which extends through its whole length from the first end 412 to the second end 414. The first end 412 of the tapered body 410 has a rectangular shape so that the cavity at the first end 412 is also provided with a rectangular shape. The second end 414 of the tapered body 410 has a circular shape so that the cavity at the second end 414 is also provided with a circular shape. The body 410 is tapered so that the size of the cavity defined therein increases from the first end 412 of the body 410 to the second end 414 and the shape of the body passes from a rectangular shape at its end 412 to a circular shape at its end 414.

A first rim projects outwardly from the first end 412 of the tapered body 402 to form the first end plate 416. As a result, the first end plate 416 surrounds the perimeter of the first end 412 of the tapered body 402 and is provided with a square shape having a square aperture. The plate 412 is designed so as to be secured to a microwave generator, a microwave waveguide or a microwave tuner. For example and as illustrated in FIG. 16, the plate 416 may be provided securing holes for securing purposes.

Similarly, a second rim projects outwardly from the second end 414 of the tapered body 402 to form the second end plate 418. As a result, the second end plate 418 surrounds the perimeter of the first end 414 of the tapered body 402 and is provided with a circular shape having a circular aperture. The plate 418 is designed so as to be secured to the connection body 404. For example and as illustrated in FIG. 16, the plate 418 may be provided with securing holes for receiving bolts or screws therethrough.

It should be understood that the shapes of the first and second end plates 416 and 418 are exemplary only and may vary as along as the first end plate 416 allows the coupler 400 to be secured to a waveguide, a tuner or a microwave generator, and the second end plate 418 allows the coupler 400 to be secured to the connection body 404. For example, while the first and second end plates 416 and 418 extends substantially orthogonally to the longitudinal axis of the tapered body, it should be understood that other embodiments may be possible.

The connection body 404 comprises a generally tubular body 419 which extends along a longitudinal axis between a first end 420 and a second end 422. The tubular body 419 defines an internal cavity which extends along the whole length of the connection body 404 between the first and second ends 420 and 422 and is shaped and sized so as to receive the barrier body 406 therein.

The internal wall 424 of the tubular body 419 is tapered so that the internal wall 424 and the internal cavity are each provided with a truncated conical shape. In the illustrated embodiment, the diameter of the internal wall 424 (or the diameter of the cavity) at the first end 420 is less than that of the internal wall 424 (or of the cavity) at the second end 422. However, the person skilled in the art would understand that other configurations may be possible. For example, the diameter of the internal wall 424 may be constant along the length of the tubular body 419. In another example, the diameter of the internal wall 424 at the first end 420 is greater than that of the internal wall 424 at the second end 422.

While in the illustrated embodiment, the diameter of the internal wall 424 has a constant diameter along a given section adjacent to the first end 422 of the tubular body 419 before decreasing towards the first end 420, it should be understood that other configurations may be possible. For example, the diameter of the internal wall 424 may be decreasing from the second end 422 to the first end 420 of the tubular body 419.

The connection body 404 further comprises a first annular plate 426 secured to the first end 420 of the tubular body 419 and a second annular plate 428 secured to the second end 422 of the tubular body 419. The first annular plate 426 comprises a circular aperture extending therethrough and the diameter of the circular aperture is substantially equal to the diameter of the cavity defined by the tubular body 419 at the first end 420 thereof. The second annular plate 428 also comprises a circular aperture extending therethrough and the diameter of the circular aperture is substantially equal to the diameter of the cavity defined by the tubular body 419 at the second end 422 thereof. The plate 428 is designed so as to be secured to a microwave reactor. For example and as illustrated, the plate 428 may be provided with holes extending therethrough for receiving therein bolts or screws. Similarly, the plate 426 is designed so as to be secured to the plate 418 of the body 402, and may also be provided with apertures extending therethrough for receiving bolts or screws.

While the plates 426 and 428 each have an annual shape, it should be understood that the plates 426 and 428 may have any other adequate shape as long as they each comprise their respective aperture therethrough.

Referring back to FIGS. 16 and 17, the barrier body 406 is sized and shaped so as to be received within the cavity of the tubular body 419. The barrier body extends longitudinally between a first end 430 and a second end 432. The barrier body 406 is provided with a truncated conical shape so that its diameter decreases from the second end 432 to the first end 430.

In the illustrated embodiment, the coupler 400 further comprises a seal 434 to be positioned within the cavity of the tubular body 419 between the internal wall of the tubular body 419 and the barrier body 406. The seal 434 has a truncated conical shape, i.e. a generally tubular shape with a varying diameter. The seal 434 extends a longitudinal axis between a first end 436 and a second end 438 and defines a barrier receiving cavity which extends through the whole length of the seal 434 from the first end 436 to the second end 438. The external and internal diameter of the seal 434 decreases from the first end 436 towards the second end 438.

The external diameter of the seal 434 substantially matches the internal diameter of the tubular body 419 so that the seal 434 may snuggingly fit into the tubular body 419 and the internal diameter of the seal 434 substantially matches the diameter of the barrier body 406 so that the barrier body 406 may snuggingly fit into the seal 434.

In the illustrated embodiment, the length of the barrier body 406, i.e. the distance between the first end 430 and the second end 432, is shorter than that of the seal 434. However, the person skilled in the art would understand that other configurations may be possible. For example, the length of the barrier body 406 may be substantially equal to that of the tubular body 419.

In one embodiment, the coupler 400 further comprises an annular gasket 450 to be inserted between the annular pate 426 of the connection body 404 and the end plate 418 of the mode conversion body 402. In the same or another embodiment, the coupler 400 comprises an annular gasket 452 to be inserted between the plate 428 of the connection body 404 and the reactor.

In one embodiment, the seal 430 may be omitted. In this case, the diameter of the barrier body 406 matches the internal diameter of the tubular body 419 so that the barrier 406 may snuggingly fit directly into the tubular body 419.

In one embodiment, the plates 416, 418, 426 and 428 are each provided with holes extending along their perimeter for securing the mode conversion body 402 to the connection body 404, the connection body 404 to a reactor and the mode conversion body 402 to a tuner, a waveguide or a microwave generator.

Once the coupler 400 assembled, the seal 434 is positioned into the tubular body 419 of the connection body 404 so that the end 438 of the seal 434 be substantially aligned or coplanar with the end 422 of the tubular body 419. The barrier body 406 is located inside the seal 434 so that the end 430 of the barrier body 406 be substantially aligned or coplanar with the end 436 of the seal 434.

The gasket 450 is positioned between the plate 418 of the mode conversion body 402 and the annular plate 426 of the connection body 404. The mode conversion body 402 and the connection body 404 are secured together using bolts and nuts for example. Each bolt is inserted through a respective hole of the plate 418 of the mode conversion body 402 and a respective hole of the annular plate 426 of the connection body 404.

In operation, the coupler 400, i.e. the mode conversion body 402 of the coupler 400, is operatively connected directly or indirectly to a microwave generator. For example, the plate 416 of the mode conversion body 402 may be secured to a tuner such as tuner 14 so that the mode conversion body 412 may receive microwaves from the tuner. In another example, the plate 416 of the mode conversion body 402 may be secured to a waveguide so that the mode conversion body 412 may receive microwaves from the waveguide. In a further example, the plate 416 of the mode conversion body 402 may be secured to a microwave generator so that the mode conversion body 412 may receive microwaves therefrom.

The coupler 400 is further operatively connected to the reactor in which pyrolysis is to occur, such as reactor 12. The gasket 452 is positioned between the annular plate 428 and the reactor and the annular plate 428 is secured to the reactor so as to propagate microwaves therein.

The mode conversion body 402 receives microwaves at its end 412 and the microwaves propagate within the cavity defined by the tapered body 410 from the rectangular end 412 towards the circular end 414. During the propagation within the cavity, the propagation mode of the microwaves changes due to the change of geometry of the tapered body 430 from a rectangular shape at the end 412 to a circular shape at the end 414. More specifically, the propagation mode passes from a TE mode at the end 412 to an LP mode at the end 414. The then converted LP mode microwaves then propagate through the barrier body 406 and into the reactor to which the connection body 404 is secured.

It should be understood that the cross-sectional dimension of the ends 412 and 414 is chosen as a function of the microwave frequency so that the cut-off frequency of the ends 412 and 414 be lower than the microwave frequency. In one embodiment, the cut-off frequency of the end 412 and 414 is mainly determined by its largest cross-sectional dimension. It should also be understood that the relative cross-sectional dimensions of the ends 412 and 414 may vary. For example, the largest cross-sectional dimension of the end 412 may be larger than that of the end 414. In another example, the largest cross-sectional dimension of the end 412 may be less than that of the end 414.

While the above description refers to bolts and nuts for removably securing the mode conversion body 402 and the connection body 404 together, it should be understood that any adequate securing means for removably securing the mode conversion body 402 and the connection body 404 together may be used.

While in the illustrated embodiment the mode conversion body 402 and the connection body 404 are independent from one another, the mode conversion body 402 and the connection body 404 could be integral to form a single piece. In this case, the plates 418 and 426 may be omitted so that the end 414 of the tapered body 430 be connected to the end 420 of the tubular body 419.

In one embodiment, the coupler 400 may be used when the pressure within the reactor is greater than the surrounding pressure such as the pressure within the mode conversion body 402. In this case, the difference between the pressure within the reactor and the pressure within the mode conversion body 402 creates a force exerted on the barrier body 406 towards the mode conversion body 402, which pushes the barrier body 406 against the internal wall of the seal 434 and the seal 434 against the internal wall of the tubular body 419, thereby improving the sealing of the coupler 400.

In one embodiment, the inner diameter of the connection body 304, 404 is chosen so as to be at least equal to the effective wavelength of the microwaves to be propagated into the reactor in order to ensure proper transmission of the microwave power through the coupler 300, 400.

In one embodiment, the connection body 304, 404 is designed so as to withstand the working pressure of the vessel.

In one embodiment, the connection body 304, 404 and the seal 334, 434 are each provided with a surface finish that enables complete gas sealing at operating conditions.

In one embodiment, the circular shape of the connection body 304, 404 allows for reducing the intensity of the maximum electrical field norm at the surface of the barrier 306, 406. In one embodiment, by switching the geometry from a rectangular waveguide to a circular waveguide, the maximum electrical field intensity can be reduced by a factor comprised between about 2 to about 10. By reducing the maximum electrical field intensity at the surface of the barrier 306, 406, it is possible to prevent electrical breakdown to occur at the surface of the barrier 306, 406 which in turn may prevent melting of the surface of the connection body 304, 404 and formation of electrical arcs. Therefore, the formation of arcs may be prevented by reducing the effective maximum electrical field intensity on the surface of the barrier 306, 406.

In one embodiment, the circular shape of the connection body 304, 404 allows for better sealing of the barrier 306, 406 by having a circular radial seal 334, 434 instead of a rectangular seal that would be needed if a standard rectangular waveguide shape would be used.

In one embodiment, during installation of the barrier 306, 406 inside the coupler 300, 400 and compression of the radial seal 304, 404, the coupler 300, 400 may be heated at or above the operating temperature to compress the seal 334, 434 and maintain the seal 334, 434 between the barrier 306, 406 and the connection body 304, 404 by press fit.

In an embodiment in which the coupler 300 is used with a reactor operated in low pressure conditions, the coupler 300 may be provided with a port 360 for injecting a fluid into the coupler 300. In this case, a back pressure may be applied on the barrier 306 from the waveguide side by injecting a pressurized gas through the port 360. The pressure of the gas is chosen so that the pressure inside the coupler 300 be greater than the pressure within the reactor. The injection of the pressurized gas within the coupler 300 ensures that the barrier 306 is maintained in position within the connection body 304 and also prevents fugitive emissions of potentially hazardous gases from diffusing into the coupler 300 from the reactor. In one embodiment, an inert gas such as nitrogen is injected into the coupler 300.

The coupler may vary depending on the conditions inside the reactor. In an embodiment, in which the reactor contains solids and a viscous slurry phase, the coupler 300′ may allow for a reduction of potential dead zones for solids and gas accumulation

In an embodiment in which the reactor a viscous slurry phase that rigidifies at lower temperatures, the coupler is provided with a jacket for the circulating a temperature control fluid therein in order to heat the housing during start-up of the reactor and/or for temperature control during operation.

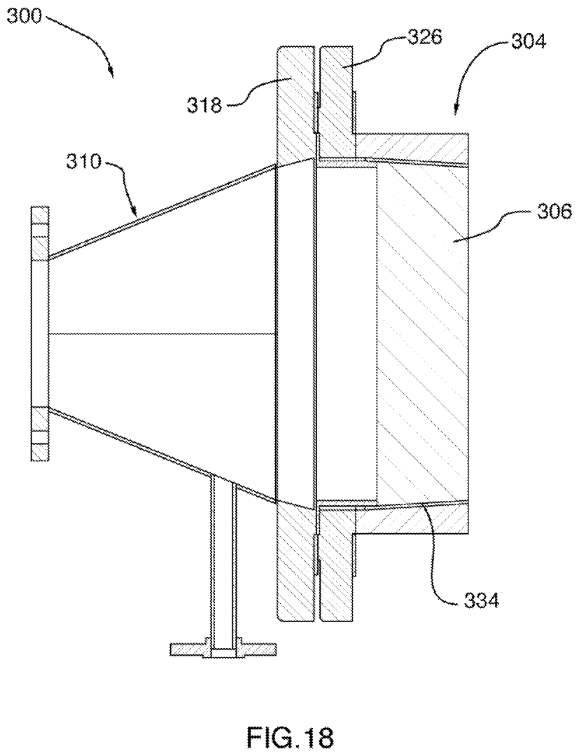

In an embodiment in which solids are present in the reactor, the coupler 300, 400 may be modified so as reduce or minimize the dead zone located in front of the barrier 306, 406 in order to avoid accumulation of solids which may interact with the microwaves and affect performance. For example, FIG. 18 illustrates a coupler 300′ which corresponds to the coupler 300 from which the plate 328 has been removed and the length of the connection body 304 has been shortened so that the front part of the modified coupler 300′ may be inserted into the reactor and protrude inside the reactor. Such a protruding design reduces accumulation of solids in front of the barrier 306 by keeping to minimum the dead zone present in front of the barrier 306.

Such a protruding design may also be used when a viscous slurry phase is present in the reactor and the products are gaseous. Reducing or minimizing the dead zone in front of the barrier 306 may reduce or avoid accumulation of gas bubbles which may interact with the microwaves and affect the reactor's performance by creating potential areas for arcing and meltdown.

In at least some high temperature applications, the interface seal 334, 434 may be made of highly conductive metal such as aluminum or brass in order to prevent generation of heat while microwave energy is applied. The material for the seal 334, 434 is preferably designed so that it takes more thermal expansion under heat stress than the connection body 304, 404 and the barrier 306, 406 to allow the seal 334, 434 to expand between the connection body 304, 404 and the barrier 306, 406 when the temperature is increased.

In at least some low temperature applications, the interface seal 334, 434 may be either made of highly conductive metal such as aluminum or brass or non-conductive or semi-conductive elastomers with low dielectric loss factor in order to minimize the heat dissipation around the barrier material while microwaves are injected. The elastomers should be compatible with a microwave environment. For example, threaded composite elastomers containing metal wires should be avoided as they tend to create arcs when the microwave field is applied and therefore may subject the barrier material to additional heat stress and cause potential failures. Exemplary adequate elastomers comprise silicon and Teflon™. In one embodiment, the material is chemically compatible with the products present in the reactor to avoid degradation during operation;

In one embodiment, the barrier 306, 406 is made of material having a low electrical conductivity in order to maximize microwave transmission and/or a low dielectric loss to prevent dissipation of microwave energy inside the interface material. In the same or another embodiment, the barrier 306, 406 is made of material chosen to be chemically compatible with the products present in the reactor to avoid degradation during operation, able to withstand the reaction temperature and temperature variations in the reactor and/or able to withstand the reaction pressure at which the reactor is operating.

In one embodiment, the material of the barrier 306, 406 is chosen to have a surface polish adequate for avoiding/reducing accumulation of microwave absorbing material or electrically conductive material on the surface of the barrier 306, 406.

In some embodiments such as for at least some low temperature environments, the barrier 306, 406 may be made of Teflon.

In other embodiments such as for at least some high temperature applications, the barrier 306, 406 may be made of aluminum oxide, silicon nitride or quartz.

In one embodiment, the barrier 306, 406 is composed of several layers of materials to benefit from the chemical and thermal properties of the different materials.

In one embodiment, the length L of the transition or tapered section of the body 310, 410 is chosen as a function of the wavelength λ of the microwaves. In one embodiment, the transition length L is chosen so that: λ/2<L<5λ.

This microwave absorbing material may be solid like carbon black, graphite or silicon carbide or it may also be a liquid like water.

The embodiments of the invention described above are intended to be exemplary only. The scope of the invention is therefore intended to be limited solely by the scope of the appended claims.

1. A coupler for propagating microwaves into a microwave pyrolysis reactor, the coupler comprising:
an elongated hollow body for propagating the microwaves, the elongated hollow body extending between a receiving end for receiving the microwaves and a transmitting end mountable to the microwave pyrolysis reactor for propagating the microwaves therein, the receiving end having a rectangular cross-sectional shape and the transmitting end having a circular cross-sectional shape, a shape of the elongated allow body being designed so as configured to convert a transverse (TE) mode of propagation for the microwaves at the receiving end thereof into a linearly polarized (LP) mode of propagation for the microwaves at the transmitting end thereof; and
a barrier body inserted into the hollow body for isolating the receiving end of the elongated hollow body from the transmitting end thereof.

2. The coupler of claim 1, wherein the elongated hollow body comprises:
a mode conversion body for receiving the microwaves and converting the TE mode of propagation of the received microwaves into the LP mode of propagation; and
a connection body mountable to the microwave pyrolysis reactor for propagating the microwaves having the LP mode of propagation therein, the connection body being hollow and the barrier body being inserted into the connection body.

3. The coupler of claim 3, wherein the mode conversion body comprises a hollow and tapered body defining a conversion cavity extending therethrough, and the connection body comprises a tubular body defining a receiving cavity, the barrier body being inserted into the receiving cavity.

4. The coupler of claim 3, wherein the hollow and tapered body extends between a first end having a rectangular shape for receiving the microwaves and a second end having a circular shape for coupling the microwaves into the connection body, a shape of the hollow and tapered body being tapered between the first and second ends thereof for converting the TE mode of propagation into the LP mode of propagation.

5. The coupler of claim 4, wherein a cross-sectional size of the first end of the hollow and tapered body is less than a cross-sectional size of the second end of the hollow and tapered body.

6. The coupler of claim 3, wherein the tubular body comprises an internal cylindrical surface surrounding the receiving cavity, at least a section of the internal cylindrical surface being tapered, and wherein a lateral surface of the barrier body is tapered so that the barrier body has a truncated conical shape and the barrier body is inserted into the receiving cavity.

7. The coupler of claim 6, wherein the tubular body extends longitudinally between a first end connected to the mode conversion body and a second end mountable to the microwave pyrolysis reactor, an internal diameter of the first end of the tubular body being greater than an internal diameter of the second end of the tubular body.

8. The coupler of claim 7, further comprising a seal body having a tapered tubular shape, the seal body being inserted into the tubular body and the barrier body being inserted into the seal body.

9. The coupler of claim 7, further comprising a backup body having a tubular shape inserted into the tubular body so that the barrier body be positioned between the backup body and the second end of the tubular body.

10. The coupler of claim 6, wherein the tubular body extends longitudinally between a first end connected to the mode conversion body and a second end mountable to the microwave pyrolysis reactor, an internal diameter of the second end of the tubular body being greater than an internal diameter of the first end of the tubular body.

11. The coupler of claim 10, further comprising a seal body having a tapered tubular shape, the seal body being inserted into the tubular body and the barrier body being inserted into the seal body.

12. The coupler of claim 3, wherein an internal diameter of the tubular body is at least equal to a wavelength of the microwaves.

13. The coupler of claim 3, wherein a length of the hollow and tapered body is longer than half of the wavelength of the microwaves and shorter than 5 times the wavelength of the microwaves.

14. The coupler of claim 1, wherein the mode conversion body and the connection body are integral.

15. The coupler of claim 1, wherein the mode conversion body and the connection body are removably secured together.

16. The coupler of claim 15, further comprising a gasket inserted between the mode conversion body and the connection body.

17. The coupler of claim 2, further comprising a port for injecting a fluid within the coupler.

18. The coupler of claim 17, wherein the port is located on the mode conversion body.

19. The coupler of claim 1, wherein the barrier body is made of a material that at least one of maximizes a microwave transmission and reduces a dissipation of microwave energy.

20. The coupler of claim 19, wherein the barrier body is made of one of: Teflon™, aluminum oxide, silicon nitride and quartz.
